(19) United States
(12) Patent Application Publication
(10) Pub. No.: US 2026/0308347 A1
(43) Pub. Date: Oct. 8, 2026

(54) POROUS ALPHA-1,3-GLUCAN COMPOSITIONS

(71) Applicant: Nutrition & Biosciences USA 4, Inc., Wilmington, DE (US)

(72) Inventors: Sefiu A. Rasaki, Calgary (CA); Steven L. Bryant, Calgary (CA); Milana Trifkovic, Calgary (CA); Natnael Behabtu, Leiden (NL); Christian Lenges, Wilmington, DE (US)

(21) Appl. No.: 19/482,253

(22) PCT Filed: Jun. 27, 2024
(86) PCT No.: PCT/US2024/035735

§ 371 Date: Nov. 7, 2025

Related U.S. Application Data
(60) Provisional application No. 63/511,286, filed on Jun. 30, 2023.
(60) Provisional application No. 63/573,627, filed on Apr. 3, 2024.

(51) Int. Cl. C08J 9/28; C08B 37/00; C08K 3/22

(52) U.S. Cl. CPC C08J 9/28; C08B 37/0009; C08K 3/22; C08K 2003/2206; C08K 2003/222; C08K 2003/2241

(57) ABSTRACT

Compositions are disclosed herein comprising an aerogel or a hydrogel. The aerogel or hydrogel comprises water-insoluble alpha-glucan and metal oxide. At least about 50% of the glycosidic linkages of the water-insoluble alpha-glucan are alpha-1,3 linkages, and the metal oxide is selected from calcium oxide, magnesium oxide, titanium dioxide, or any other suitable metal oxide. Methods of producing aerogels and hydrogels are also disclosed, as well as methods of using these materials, such as in absorption techniques. Other types of materials containing water-insoluble alpha-glucan are also disclosed.

This application claims the benefit of U.S. Provisional Appl. Nos. 63/511,292 (filed Jun. 30, 2023), 63/511,286 (filed Jun. 30, 2023), and 63/573,627 (filed Apr. 3, 2024), which are each incorporated herein by reference in their entirety.

### FIELD

The present disclosure is in the field of polysaccharides. For example, the disclosure pertains to porous compositions that comprise insoluble alpha-glucan having alpha-1,3 glycosidic linkages. Aerogels and hydrogels are examples of porous compositions herein.

### BACKGROUND

Driven by a desire to use polysaccharides in various applications, researchers have explored for polysaccharides that are biodegradable and that can be made economically from renewably sourced feedstocks. One such polysaccharide is alpha-1,3-glucan, an insoluble glucan polymer characterized by having alpha-1,3-glycosidic linkages. This polymer has been prepared, for example, using a glucosyltransferase enzyme isolated from Streptococcus salivarius (Simpson et al., Microbiology 141:1451-1460, 1995). Also for example, U.S. Pat. No. 7,000,000 disclosed the preparation of a spun fiber from enzymatically produced alpha-1,3-glucan. Various other glucan materials have also been studied for developing new or enhanced applications. For example, U.S. Patent Appl. Publ. No. 2015/0232819 discloses enzymatic synthesis of several insoluble glucans having mixed alpha-1,3 and -1,6 linkages.

An aerogel is a solid-state porous material derived from a gel that has been treated to replace its liquid contents with air. Generally, aerogels can contain at least about 99 wt % air, therefore qualifying them as ultra-light weight materials. Aerogels are useful in applications of absorption/adsorption, drug delivery and catalysis, for example, due to their high surface area and porosity, while their insulating properties also render them useful in thermal insulation and packaging applications. Different glucan polymers such as cellulose and chitosan have previously been tested in synthesizing aerogels, but these and other polysaccharides-based aerogels have generally been found to be prone to issues of structural discontinuity, uneven pore distribution, and formation of large pores that can cause significant shrinkage, structure collapse, and brittleness. These features can negatively impact the water retention capacity of an aerogel. Thus, aerogels made with formulations that allow better functionality are desired. Aerogels comprising alpha-1,3-glucan are disclosed herein, for example, to help address this need.

### SUMMARY

In one embodiment, the present disclosure concerns a composition comprising an aerogel, wherein the aerogel comprises at least a water-insoluble alpha-glucan and a metal oxide, wherein at least about 50% of the glycosidic linkages of the insoluble alpha-glucan are alpha-1,3 linkages, and wherein the metal oxide is calcium oxide (CaO), magnesium oxide (MgO), or titanium dioxide (TiO₂).

In another embodiment, the present disclosure concerns an aqueous caustic solution comprising (i) an aqueous caustic solvent, (ii) a water-insoluble alpha-glucan, and (iii) a metal hydroxide, wherein at least about 50% of the glycosidic linkages of the water-insoluble alpha-glucan are alpha-1,3 glycosidic linkages, wherein the water-insoluble alpha-glucan is dissolved in the aqueous caustic solvent and the metal hydroxide is not dissolved in the aqueous caustic solvent, and wherein the metal hydroxide is calcium hydroxide, magnesium hydroxide, or titanium hydroxide.

In another embodiment, the present disclosure concerns a method/process of producing an aerogel herein, the method comprising: (a) providing an aqueous caustic solution herein, (b) putting the aqueous caustic solution into a desired form, (c) chemically or ionically modifying the aqueous caustic solvent such that the water-insoluble alpha-glucan and the metal hydroxide are undissolved in the solvent, whereby a hydrogel is produced, and (d) removing all of the water, or most of the water, from the hydrogel, whereby an aerogel is produced.

### BRIEF DESCRIPTION OF THE DRAWINGS

FIG. 1: This figure represents the typical scheme used herein for synthesizing hybrid hydrogels and hybrid aerogels. Refer to Examples.

FIG. 2: SEM imaging of neat glucan aerogel (a) and hybrid aerogels having magnesium oxide (b), calcium oxide (c), or titanium oxide (d). Each image contains a 50-mm reference bar and an inset image with a 5-mm reference bar. Refer to Examples.

FIG. 3: Water absorption by hybrid glucan and neat glucan aerogels over time. The inset chart shows water absorption of the aerogels under load. Key: neat glucan (main chart: triangles of lowest line, as indicated; inset chart: diamonds of lowest line, as indicated), MgO-glucan (circles), CaO-glucan (triangles), TiO₂-glucan (squares). Refer to Examples.

FIG. 4: Saline absorption by hybrid glucan and neat glucan aerogels over time. The inset chart shows saline absorption of the aerogels under load. Key: neat glucan (main chart: diamonds of lowest line, as indicated; inset chart: squares of lowest line, as indicated), MgO-glucan (circles), CaO-glucan (triangles), TiO₂-glucan (squares). Refer to Examples.

FIG. 5A: Glycerol:water (1:10) (v/v) absorption by hybrid glucan and neat (pure) glucan aerogels over time. Key: neat (pure) glucan (diamonds), MgO-glucan (circles), CaO-glucan (triangles), TiO₂-glucan (squares). Refer to Examples.

FIG. 5B: Glycerol:water (1:1) (v/v) absorption by hybrid glucan and neat (pure) glucan aerogels, under load, over time. Key: neat (pure) glucan (diamonds), MgO-glucan (circles), CaO-glucan (triangles), TiO₂-glucan (squares). Refer to Examples.

FIG. 5C: Glycerol:water (1:10, 1:1, or 5:1) (v/v) absorption by hybrid glucan (MgO-, CaO-, or TiO₂-glucan) and neat (pure) glucan aerogels at 100 seconds. Absorption capacities of a commercial diaper and commercial pad were also measured. The viscosity of each glycerol-water solution is listed.

### DETAILED DESCRIPTION

The disclosures of all cited patent and non-patent literature are incorporated herein by reference in their entirety.

Unless otherwise disclosed, the terms “a” and “an” as used herein are intended to encompass one or more (i.e., at least one) of a referenced feature.

Where present, all ranges are inclusive and combinable, except as otherwise noted. For example, when a range of “1 to 5” (i.e., 1-5) is recited, the recited range should be construed as including ranges “1 to 4”, “1 to 3”, “1-2”, “1-2 & 4-5”, “1-3 & 5”, and the like. The numerical values of the various ranges in the present disclosure, unless expressly indicated otherwise, are stated as approximations as though the minimum and maximum values within the stated ranges were both proceeded by the word “about”. In this manner, slight variations above and below the stated ranges can typically be used to achieve substantially the same results as values within the ranges. Also, the disclosure of these ranges is intended as a continuous range including each and every value between the minimum and maximum values.

It is intended that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

It is to be appreciated that certain features of the present disclosure, which are, for clarity, described above and below in the context of aspects/embodiments, may also be provided in combination in a single element. Conversely, various features of the disclosure that are, for brevity, described in the context of a single aspect/embodiment, can also be provided separately or in any sub-combination; i.e., the aspects/embodiments disclosed herein relate, where applicable, to all other aspects/embodiments of the disclosure, even if such applicability is not separately disclosed herein.

A “glucan” herein is a type of polysaccharide that is a polymer of glucose (polyglucose). A glucan can be comprised of, for example, about, or at least about, 90%, 91%, 92%, 93%, 94%, 95%, 96%, 97%, 98%, 99%, or 100% by weight glucose monomeric units. An example of a glucan herein is alpha-glucan.

The terms “alpha-glucan”, “alpha-glucan polymer” and the like are used interchangeably herein. An alpha-glucan is a polymer comprising glucose monomeric units linked together by alpha-glycosidic linkages. In typical aspects, the glycosidic linkages of an alpha-glucan herein are about, or at least about, 80%, 81%, 82%, 83%, 84%, 85%, 86%, 87%, 88%, 89%, 90%, 91%, 92%, 93%, 94%, 95%, 96%, 97%, 98%, 99%, or 100% alpha-glycosidic linkages. An example of an alpha-glucan polymer herein is alpha-1,3-glucan.

The term “saccharide” and other like terms herein refer to monosaccharides and/or disaccharides/oligosaccharides, unless otherwise noted. A “disaccharide” herein refers to a carbohydrate having two monosaccharides joined by a glycosidic linkage. An “oligosaccharide” herein can refer to a carbohydrate having 3 to 15 monosaccharides, for example, joined by glycosidic linkages. An oligosaccharide can also be referred to as an “oligomer”. Monosaccharides (e.g., glucose and/or fructose) comprised within disaccharides/oligosaccharides can be referred to as “monomeric units”, “monosaccharide units”, or other like terms.

The terms “alpha-1,3-glucan”, “poly alpha-1,3-glucan”, “alpha-1,3-glucan polymer” and the like are used interchangeably herein. Alpha-1,3-glucan is an alpha-glucan comprising glucose monomeric units linked together by glycosidic linkages, wherein at least about 50% of the glycosidic linkages are alpha-1,3. Alpha-1,3-glucan in some aspects comprises about, or at least about, 90%, 95%, or 100% alpha-1,3 glycosidic linkages. Most or all of the other linkages, if present, in alpha-1,3-glucan herein typically are alpha-1,6, though some linkages may also be alpha-1,2 and/or alpha-1,4. Alpha-1,3-glucan herein is typically water-insoluble.

The terms “linkage”, “glycosidic linkage”, “glycosidic bond” and the like refer to the covalent bonds connecting the sugar monomers within a saccharide compound (oligosaccharides and/or polysaccharides). Examples of glycosidic linkages include 1,6-alpha-D-glycosidic linkages (herein also referred to as “alpha-1,6” linkages), 1,3-alpha-D-glycosidic linkages (herein also referred to as “alpha-1,3” linkages), 1,4-alpha-D-glycosidic linkages (herein also referred to as “alpha-1,4” linkages), and 1,2-alpha-D-glycosidic linkages (herein also referred to as “alpha-1,2” linkages). The glycosidic linkages of a glucan polymer herein can also be referred to as “glucosidic linkages”. Herein, “alpha-D-glucose” is referred to as “glucose”.

The glycosidic linkage profile of an alpha-glucan can be determined using any method known in the art. For example, a linkage profile can be determined using methods using nuclear magnetic resonance (NMR) spectroscopy (e.g., ¹³C NMR and/or ¹H NMR). These and other methods that can be used are disclosed in, for example, Food Carbohydrates: Chemistry, Physical Properties, and Applications (S. W. Cui, Ed., Chapter 3, S. W. Cui, Structural Analysis of Polysaccharides, Taylor & Francis Group LLC, Boca Raton, FL, 2005), which is incorporated herein by reference.

The “molecular weight” of an alpha-glucan herein can be represented as weight-average molecular weight (Mw) or number-average molecular weight (Mn), the units of which are in Daltons (Da) or grams/mole. In some aspects, molecular weight can be represented as DPw (weight average degree of polymerization) or DPn (number average degree of polymerization). DPw and DPn are calculated from the corresponding Mw or Mn, respectively, by dividing by the molar mass of one monomer unit M₁. In the case of glucan polymer, M₁=162.14. In some aspects (e.g., oligosaccharides), molecular weight can sometimes be provided as “DP” (degree of polymerization), which simply refers to the number of glucoses comprised within the alpha-glucan on an individual molecule basis. Various means are known in the art for calculating these various molecular weight measurements such as with high-pressure liquid chromatography (HPLC), size exclusion chromatography (SEC), or gel permeation chromatography (GPC).

As used herein, Mw can be calculated as Mw=ΣNiMi²/ΣNiMi; where Mi is the molecular weight of an individual chain i and Ni is the number of chains of that molecular weight. Besides SEC, the Mw of a polymer can be determined by other techniques such as static light scattering, mass spectrometry, MALDI-TOF (matrix-assisted laser desorption/ionization time-of-flight), small angle X-ray or neutron scattering, or ultracentrifugation. As used herein, Mn can be calculated as Mn=ΣNiMi/ΣNi where Mi is the molecular weight of a chain i and Ni is the number of chains of that molecular weight. Besides SEC, the Mn of a polymer can be determined by various colligative property methods such as vapor pressure osmometry, end-group determination by spectroscopic methods such as proton NMR, proton FTIR, or UV-Vis.

The term “hydrogel” and like terms as used herein refer to a biphasic material/composition of porous, permeable solids and typically at least 10% by weight or volume of aqueous fluid (“interstitial aqueous fluid”) (typically 100 wt % water, or an aqueous liquid of water and one or more other types of liquid such as a suitable polar organic solvent [e.g., ethanol, isopropanol]). The hydrogel solids component is a water-insoluble three-dimensional network comprising at least alpha-1,3-glucan and a metal oxide such as calcium hydroxide [Ca(OH)₂], magnesium hydroxide [Mg(OH)₂], or titanium hydroxide [Ti(OH)₄](or any other hydroxide of an alkali earth metal or transition metal, which metal hydroxide is suitable for producing a hydrogel of alpha-1,3-glucan).

The terms “aerogel”, “solid foam”, “sponge”, “solid sponge” and the like as used herein refer to a porous material/composition derived from an aqueous gel (hydrogel) from which the liquid component (typically of water only, but optionally further comprising one or more other types of liquid) has been replaced with a gas (e.g., standard atmospheric air). Thus, an aerogel typically is a dry/dried composition, though it can be made wet in water absorption applications. An aerogel herein generally is a nanoporous material/composition with various properties such as low density, low thermal conductivity, enhanced strength/stiffness, and/or high specific internal surface area. An aerogel of the present disclosure comprises at least alpha-1,3-glucan and a metal oxide such as calcium oxide (CaO), magnesium oxide (MgO), or titanium dioxide (TiO₂) (or any other oxide of an alkali earth metal or transition metal, which metal oxide is suitable for producing an aerogel of alpha-1,3-glucan). Given this combination of metal oxide and alpha-1,3-glucan, such an aerogel can optionally be characterized herein as a “hybrid alpha-1,3-glucan aerogel” (and like terms), as opposed to an aerogel that comprises alpha-1,3-glucan only (a “neat” or “pure” alpha-1,3-glucan aerogel).

The terms “particle”, “particulate” and like terms are interchangeably used herein, and refers to the smallest identifiable unit in a particulate system. In some aspects, a composition can be characterized to have been “comminuted”, meaning that the composition has been reduced from a larger size to particles (e.g., by crushing, grinding, pulverizing, and/or any other suitable means). Particle size in some aspects can refer to particle diameter and/or the length of the longest particle dimension. The average size can be based on the average of diameters and/or longest particle dimensions of at least 50, 100, 500, 1000, 2500, 5000, or 10000 or more particles, for example. Particle size herein can be measured by a process comprising light scattering or electrical impedance change (e.g., using a Coulter Counter), for example, such as described in any of U.S. Pat. Nos. 6,091,492, 6,741,350, or 9297737 (each incorporated herein by reference). Particle size herein can optionally be expressed by a “D₁₀”, “D₅₀”, “D₉₀”, etc. value, for example, a D₅₀ value is the diameter for which 50% by weight of the particles in a composition (e.g., a powder of an aerogel herein) have a diameter under that diameter, and 50% by weight of the particles have a diameter greater than that diameter.

The terms “hydrogen bond”, “hydrogen bonding” and the like herein refer to electromagnetic attraction that is not a covalent bond, ionic bond, or van der Waals forces. A hydrogen bond is weaker than ionic and covalent bonds, but stronger than van der Waals forces. Typically, a hydrogen atom involved in a hydrogen bond herein is directly bonded to an oxygen atom (of a hydroxyl group) of a glucose monomeric unit of an alpha-glucan, which hydrogen atom interacts electrostatically with an oxygen atom of a metal oxide. This hydrogen bonding can optionally be characterized as intermolecular, since it occurs between an alpha-glucan molecule and a metal oxide molecule.

The terms “aqueous liquid”, “aqueous fluid”, “aqueous conditions”, “aqueous reaction conditions”, “aqueous setting”, “aqueous system” and the like as used herein can refer to water or an aqueous solution. An “aqueous solution” herein can comprise one or more dissolved salts, where the maximal total salt concentration can be about 3.5 wt % in some aspects. Although aqueous liquids herein typically comprise water as the only solvent in the liquid, an aqueous liquid can optionally comprise one or more other solvents (e.g., polar organic solvent) that are miscible in water. Thus, an aqueous solution can comprise a solvent having at least about 10 wt % water.

An “aqueous composition” herein has a liquid component that comprises about, or at least about, 10, 20, 30, 40, 50, 60, 70, 80, 90, 95, 99, or 100 wt % water, for example. Examples of aqueous compositions include some mixtures, solutions, dispersions (e.g., colloidal dispersions), suspensions and emulsions, for example.

An alpha-glucan that is “insoluble”, “aqueous-insoluble”, “water-insoluble” (and like terms) (e.g., alpha-1,3-glucan with a DP of 8 or higher) herein does not dissolve (or does not appreciably dissolve) in water or other aqueous conditions, optionally where the aqueous conditions are at a pH of 4-9 (e.g., pH 6-8) and/or temperature of about 1 to 130° C. (e.g., 20-25° C.). In some aspects, less than 1.0 gram (e.g., no detectable amount) of an aqueous-insoluble alpha-glucan herein dissolves in 1000 milliliters of such aqueous conditions (e.g., water at 23° C.). In contrast, glucans such as certain oligosaccharides herein that are “soluble”, “aqueous-soluble”, “water-soluble” and the like (e.g., alpha-1,3-glucan with a DP less than 8) appreciably dissolve under these conditions.

A “dope solution”, “dope”, “caustic solution”, “basic solution”, “alkaline solution” and the like herein refer to a solution (typically aqueous with pH≥11) in which, at least, a water-insoluble alpha-glucan (e.g., being insoluble in aqueous solution of pH 4-9) is dissolved.

The terms “freeze-drying”, lyophilization” and the like herein refer to a process in which a wet composition (e.g., a hydrogel herein) (e.g., wet with water, polar organic solvent, or combination thereof) is rapidly frozen (freezing step), and then subjected to a high vacuum (to provide lower air pressure) to remove frozen water by sublimation (primary drying step). Freeze-drying herein can optionally comprise a secondary drying step in which the temperature is raised higher (and pressure typically lowered further) than in the primary drying phase.

The terms “supercritical drying”, “critical point drying” and the like herein refer to a process by which the liquid (e.g., water, polar organic solvent, or combination thereof) in a wet composition (e.g., a hydrogel herein) is transformed into gas in the absence of surface tension and capillary stress. Supercritical drying can be performed using supercritical carbon dioxide (CO₂), for example. Supercritical CO₂ is a fluid state of CO₂ where it is held at or above its critical temperature and critical pressure.

The terms “sequence identity”, “identity” and the like as used herein with respect to a polypeptide amino acid sequence (e.g., that of a glucosyltransferase) can be as defined and determined in U.S. Patent Appl. Publ. No. 2017/0002336, which is incorporated herein by reference.

Various polypeptide amino acid sequences are disclosed herein as features of certain embodiments. Variants of these sequences that are at least about 70-85%, 85-90%, or 90%-95% identical to the sequences disclosed herein can be used or referenced. Alternatively, a variant amino acid sequence can have at least 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, 99%, or 99.5% identity with a sequence disclosed herein. The variant amino acid sequence has the same function/activity of the disclosed sequence, or at least about 80%, 81%, 82%, 83%, 84%, 85%, 86%, 87%, 88%, 89%, 90%, 91%, 92%, 93%, 94%, 95%, 96%, 97%, 98%, or 99% of the function/activity of the disclosed sequence.

A composition herein such as an aerogel that is “dry” or “dried” typically has less than about 3, 2, 1, 0.5, or 0.1 wt % water comprised therein.

The term “viscosity” as used herein refers to the measure of the extent to which a fluid (aqueous or non-aqueous) resists a force tending to cause it to flow. Various units of viscosity that can be used herein include centipoise (cP, cps) and Pascal-second (Pa-s), for example. A centipoise is one one-hundredth of a poise; one poise is equal to 0.100 kg·m⁻¹·s⁻¹. Viscosity can be reported as “intrinsic viscosity” (IV, □, units of dL/g) in some aspects; this term refers to a measure of the contribution of a glucan polymer to the viscosity of a liquid (e.g., solution) comprising the glucan polymer. IV measurements herein can be obtained, for example, using any suitable method such as disclosed in U.S. Pat. Appl. Publ. Nos. 2017/0002335, 2017/0002336, or 2018/0340199, or Weaver et al. (J. Appl. Polym. Sci. 35:1631-1637) or Chun and Park (Macromol. Chem. Phys. 195:701-711), which are all incorporated herein by reference. IV can be measured, in part, by dissolving glucan polymer (optionally dissolved at about 100° C. for at least 2, 4, or 8 hours) in DMSO with about 0.9 to 2.5 wt % (e.g., 1, 2, 1-2 wt %) LiCl, for example. IV herein can optionally be used as a relative measure of molecular weight.

The terms “absorb”, “absorption” and like terms as used herein refer to the action of taking up (soaking up) a liquid (e.g., aqueous liquid). Absorption by a composition as presently disclosed can be measured in terms of water absorption capacity as disclosed herein, for example. An “absorbent” herein is a product/composition that can exhibit absorption when placed in contact with water or other aqueous composition/liquid.

The term “under load” and like terms herein characterize conditions in which pressure or weight is applied to a composition or product herein. Typically, such conditions, when applied to a composition, can reduce the ability of the composition to absorb an aqueous liquid, or, if an aqueous liquid has already been absorbed by the composition, under-load conditions can act to reduce the amount the absorbed aqueous liquid (e.g., some absorbed aqueous liquid can be forced out of the composition under load).

The terms “polar organic solvent” and “water-miscible organic solvent” (and like terms) are used interchangeably herein. A polar organic solvent can be dissolved in water or an aqueous solution. Thus, a polar organic solvent does not separate out into a different phase when added to water or an aqueous solution. A polar organic solvent contains carbon and at least one heteroatom (i.e., non-carbon or -hydrogen atom) such as oxygen, nitrogen, sulfur, or phosphorous. This contrasts with non-polar organic solvents, which generally comprise only carbon and hydrogen atoms. A polar organic solvent typically has a dielectric constant greater than about 4. A polar organic solvent contains dipoles due to polar bonds.

The term “protic polar organic solvent” (and like terms) herein refers to a polar organic solvent that has one or more suitably labile hydrogen atoms that can form hydrogen bonds. A protic polar organic solvent generally contains hydrogen atoms bonded to an atom with electronegative character; e.g., there are one or more O—H, N—H, and/or S—H bonds.

The term “aprotic polar organic solvent” (and like terms) herein refers to a polar organic solvent that does not have suitably labile hydrogen atoms that can form hydrogen bonds. An aprotic polar organic solvent does not contain hydrogen atoms bonded to an atom with electronegative character; e.g., there are no O—H, N—H, or S—H bonds.

The terms “household care product”, “home care product” and the like typically refer to products, goods and services relating to the treatment, cleaning, caring, and/or conditioning of a home and its contents. The foregoing include, for example, chemicals, compositions, products, or combinations thereof having application in such care.

The term “personal care product” and like terms typically refer to products, goods and services relating to the treatment, cleaning, cleansing, caring, or conditioning of a person. The foregoing include, for example, chemicals, compositions, products, or combinations thereof having application in such care.

The term “medical product” and like terms typically refer to products, goods and services relating to the diagnosis, treatment, and/or care of patients.

The term “industrial product” and like terms typically refer to products, goods and services used in industrial and/or institutional settings, but typically not by individual consumers.

A “pharmaceutical product”, “medicine”, “medication”, “drug” or like term herein refers to a composition used to treat disease or injury, and can be administered enterally or parenterally.

The terms “percent by volume”, “volume percent”, “vol %”, “v/v %” and the like are used interchangeably herein. The percent by volume of a solute in a solution can be determined using the formula: [(volume of solute)/(volume of solution)]×100%.

The terms “percent by weight”, “weight percentage (wt %)”, “weight-weight percentage (% w/w)” and the like are used interchangeably herein. Percent by weight refers to the percentage of a material on a mass basis as it is comprised in a composition, mixture, or solution, for example.

The terms “weight/volume percent”, “w/v %” and the like are used interchangeably herein. Weight/volume percent can be calculated as: ((mass [g] of material)/(total volume [mL] of the material plus the liquid in which the material is placed))×100%. The material can be insoluble in the liquid (i.e., be a solid phase in a liquid phase, such as with a dispersion), or soluble in the liquid (i.e., be a solute dissolved in the liquid).

The term “isolated” means a substance (or process) in a form or environment that does not occur in nature. Non-limiting examples of an isolated substance includes any aerogel, hydrogel, or caustic solution herein. It is believed that the embodiments disclosed herein are synthetic/man-made (could not have been made or practiced except for human intervention/involvement), and/or have properties that are not naturally occurring.

The term “increased” as used herein can refer to a quantity or activity that is at least about 1%, 2%, 3%, 4%, 5%, 6%, 7%, 8%, 9%, 10%, 11%, 12%, 13%, 14%, 15%, 16%, 17%, 18%, 19%, 20%, 50%, 100%, or 200% more than the quantity or activity for which the increased quantity or activity is being compared. The terms “increased”, “elevated”, “enhanced”, “greater than”, “improved” and the like are used interchangeably herein.

Some aspects of the present disclosure concern a composition/product comprising at least an aerogel (or foam/solid foam, or sponge/solid sponge, e.g.), wherein the aerogel comprises at least a water-insoluble alpha-glucan and a metal oxide, wherein at least about 50% of the glycosidic linkages of the insoluble alpha-glucan are alpha-1,3 linkages, and wherein the metal oxide is calcium oxide (CaO), magnesium oxide (MgO), or titanium dioxide (TiO₂) (or any other suitable oxide of an alkali earth metal or transition metal).

In some aspects, an insoluble alpha-glucan comprises about, or at least about, 50%, 60%, 70%, 80%, 85%, 86%, 87%, 88%, 89%, 90%, 91%, 92%, 93%, 94%, 95%, 96%, 97%, 98%, 99%, 99.5%, or 100% alpha-1,3 glycosidic linkages (i.e., the alpha-glucan is an alpha-1,3-glucan). In some aspects, accordingly, an insoluble alpha-glucan has about, or less than about, 50%, 40%, 30%, 20%, 15%, 10%, 9%, 8%, 7%, 6%, 5%, 4%, 3%, 2%, 1%, 0.5%, or 0% glycosidic linkages that are not alpha-1,3. Typically, the glycosidic linkages that are not alpha-1,3 are mostly or entirely alpha-1,6. In some aspects, an insoluble alpha-glucan has no branch points or less than about 5%, 4%, 3%, 2%, or 1% branch points as a percent of the glycosidic linkages in the alpha-glucan.

The DPw, DPn, or DP of an insoluble alpha-glucan in some aspects can be about, at least about, or less than about, 10, 15, 25, 50, 75, 100, 150, 200, 300, 400, 500, 600, 700, 800, 900, 1000, 1100, 1200, 1300, 1400, 1500, 1600, 1700, 1800, 1900, 2000, 2500, 3000, 3500, or 4000. DPw, DPn, or DP can optionally be expressed as a range between any two of these values. Merely as examples, the DPw, DPn, or DP can be about 50-1600, 100-1600, 200-1600, 300-1600, 400-1600, 500-1600, 600-1600, 700-1600, 50-1250, 100-1250, 200-1250, 300-1250, 400-1250, 500-1250, 600-1250, 700-1250, 50-1000, 100-1000, 200-1000, 300-1000, 400-1000, 500-1000, 600-1000, 700-1000, 50-900, 100-900, 200-900, 300-900, 400-900, 500-900, 600-900, 700-900, 600-800, or 600-750. Merely as further examples, the DPw, DPn, or DP can be about 15-100, 25-100, 35-100, 15-80, 25-80, 35-80, 15-60, 25-60, 35-60, 15-55, 25-55, 35-55, 15-50, 25-50, 35-50, 35-45, 35-40, 40-100, 40-80, 40-60, 40-55, 40-50, 45-60, 45-55, 45-50, 15-35, 20-35, 15-30, or 20-30. Merely as further examples, the DPw, DPn, or DP can be about 100-600, 100-500, 100-400, 100-300, 200-600, 200-500, 200-400, or 200-300. In some aspects, an insoluble alpha-glucan can have a high molecular weight as reflected by high intrinsic viscosity (IV), e.g., IV can be about, or at least about, 6, 7, 8, 9, 10, 11, 12, 13, 14, 15, 16, 17, 18, 19, 20, 21, 22, 6-8, 6-7, 6-22, 6-20, 6-17, 6-15, 6-12, 10-22, 10-20, 10-17, 10-15, 10-12, 12-22, 12-20, 12-17, or 12-15 dL/g (for comparison purposes, note that the IV of insoluble alpha-glucan with at least 90% (e.g., about 99% or 100%) alpha-1,3 linkages and a DPw of about 800 has an IV of about 2-2.5 dL/g). IV herein can be as measured with insoluble alpha-glucan polymer dissolved in DMSO with about 0.9 to 2.5 wt % (e.g., 1, 2, 1-2 wt %) LiCl, for example.

An insoluble alpha-glucan herein can be as disclosed (e.g., molecular weight, linkage profile, and/or production method), for example, in U.S. Pat. Nos. 7,000,000, 8,871,474, 10301604, or 10260053, or U.S. Patent Appl. Publ. Nos. 2019/0112456, 2019/0078062, 2019/0078063, 2018/0340199, 2018/0021238, 2018/0273731, 2017/0002335, 2015/0232819, 2015/0064748, 2020/0165360, 2020/0131281, 2019/0276806, or 2019/0185893, which are each incorporated herein by reference. An insoluble alpha-glucan can be produced, for example, by an enzymatic reaction comprising at least water, sucrose and a glucosyltransferase enzyme that synthesizes the insoluble alpha-glucan. Glucosyltransferases, reaction conditions, and/or processes contemplated to be useful for producing insoluble alpha-glucan can be as disclosed in any of the foregoing references.

In some aspects, a glucosyltransferase enzyme for producing an insoluble alpha-glucan herein can comprise an amino acid sequence that is 100% identical to, or at least 90%, 91%, 92%, 93%, 94%, 95%, 96%, 97%, 98%, 98.5%, 99%, or 99.5% identical to, SEQ ID NO:2, 4, 6, 8, 10, 12, 14, 16, 18, 20, 26, 28, 30, 34, or 59, or amino acid residues 55-960 of SEQ ID NO:4, residues 54-957 of SEQ ID NO:65, residues 55-960 of SEQ ID NO:30, residues 55-960 of SEQ ID NO:28, or residues 55-960 of SEQ ID NO:20, and have glucosyltransferase activity, these amino acid sequences are disclosed in U.S. Patent Appl. Publ. No. 2019/0078063, which is incorporated herein by reference. It is noted that a glucosyltransferase enzyme comprising SEQ ID NO:2, 4, 8, 10, 14, 20, 26, 28, 30, 34, or amino acid residues 55-960 of SEQ ID NO:4, residues 54-957 of SEQ ID NO:65, residues 55-960 of SEQ ID NO:30, residues 55-960 of SEQ ID NO:28, or residues 55-960 of SEQ ID NO:20, can synthesize insoluble alpha-glucan comprising at least about 90% (~100%) alpha-1,3 linkages.

Insoluble alpha-glucan herein typically does not have any chemical derivatization (e.g., etherification, esterification, phosphorylation, sulfation, oxidation, carbamation) (e.g., no substitution of hydrogens of glucan hydroxyl groups with a non-sugar chemical group). However, in some aspects, insoluble alpha-glucan can be a charged (e.g., cationic or anionic) derivative of an alpha-glucan as disclosed herein. The DoS of such a derivative typically is less than about 0.3, 0.25, 0.2, 0.15, 0.1, or 0.05. The type of derivative can be any of the foregoing derivatives (e.g., ether, ester). Typically, insoluble alpha-glucan herein is enzymatically derived in an inert vessel (typically under cell-free conditions) and is not derived from a cell wall (e.g., fungal cell wall).

A metal oxide in some aspects can be calcium oxide (CaO), magnesium oxide (MgO), or titanium dioxide (TiO₂). It is noted for reference purposes that titanium is a transition metal and calcium and magnesium are alkali earth metals. Thus, it is contemplated that a metal oxide herein can be another type of alkali earth metal oxide or transition metal oxide, for example, which metal oxide is suitable for forming an aerogel with a water-insoluble alpha-glucan of the present disclosure. Typically, an aerogel herein has one metal oxide, but in some cases an aerogel can have two or more metal oxides (e.g., CaO and MgO, CaO and TiO₂, MgO and TiO₂). A metal oxide herein, as comprised in an aerogel, can optionally be characterized as being an in situ-generated metal oxide, given how an aerogel can be produced (e.g., as disclosed herein).

A metal oxide component of an aerogel as presently disclosed typically interacts with water-insoluble alpha-glucan via hydrogen bonding. Hydrogen bonding can be multivalent, for example, such as when TiO₂ is used as a metal oxide. An aerogel or hydrogel herein typically does not contain any covalent crosslinking, whether between alpha-glucan molecules (intra- or inter-molecular) or between alpha-glucan and a metal oxide or metal hydroxide.

An aerogel herein can comprise about, or less than about, 20, 15, 10, 7.5, 6, 5, 4, 3, 2.5, 2, 1, 0.5, 0.5-10, 0.5-5, 0.5-4, 0.5-3, 0.5-2.5, 1-10, 1-5, 1-4, 1-3, 1-2.5, or 1.5-2.5 wt % of a metal oxide herein (or combination of metal oxides herein), for example. The distribution of metal oxide in an aerogel typically is of uniform distribution. In some aspects, the balance of the mass of an aerogel is of water-insoluble alpha-glucan (i.e., such an aerogel can be characterized as consisting of water-insoluble alpha-glucan and metal oxide). However, in some aspects, an aerogel can comprise one or more other components (solids) in addition to water-insoluble alpha-glucan and metal oxide. An aerogel can comprise about, or at least about, 80, 85, 90, 92.5, 94, 95, 96, 97, 97.5, 98, 99, or 99.5 wt % of water-insoluble alpha-glucan, in some aspects. An aerogel in some aspects does not comprise polyurethane or any other organic polymer (aside for the insoluble alpha-glucan), and/or does not comprise silica. The foregoing content amounts (wt %'s) can be with respect to the dry solids of an aerogel. Any solids component of an aerogel herein typically is borne from its inclusion (or in situ generation) in a process of making the aerogel (i.e., a solid component typically is not one that is present by virtue of having been absorbed into the aerogel, such as from having used an aerogel in an absorption method and then drying it). While an aerogel as produced herein (not yet used in an absorption method) typically is dry/dried (before its use in an aqueous liquid absorption method herein), it can optionally contain a trace amount of water (e.g., absorbed from atmosphere) (e.g., s 2, 1, 0.5, or 0.1 wt % of the aerogel). A hydrogel herein can comprise any of the foregoing content amounts of water-insoluble alpha-glucan and of metal hydroxide that can be used to provide any of the foregoing metal oxides, where the content amount is on a dry solids basis (dsb) (alternatively referred to as dry weight basis, dwb).

An aerogel herein is porous, typically with about, or at least about, 90%, 95%, 96%, 97%, 98%, 99%, 99.5%, 99.8%, or 99.9% porosity. Percent porosity herein can be determined by dividing the total volume of all the aerogel voids by the total volume of the aerogel itself, and multiplying by 100%. An aerogel of the present disclosure typically has an open-cell pore structure. The cells of an aerogel herein can be continuous, or semi-continuous (e.g., at least about 20%, 30%, 40%, 50%, 60%, 70%, 80%, or 90% of the pores are continuous with at least one immediately adjacent pore), for example (any two pores can be characterized as being continuous with each other if there is an open passage connecting them). Pores herein are typically present throughout the entire aerogel in a uniform manner. Typically, an aerogel herein does not comprise closed-cell pore structures (i.e., pores that are completely closed off and not continuous with any adjacent pores), or has less than 5% or 1% of pores that are closed-cell pores.

In some aspects of an alpha-glucan aerogel comprising TiO₂, the pore volume per aerogel mass can be about 0.10-0.15, 0.11-0.15, 0.12-0.15, 0.13-0.15, 0.10-0.14, 0.11-0.14, 0.12-0.14, or 0.13-0.14 cm³/g. In some aspects of an alpha-glucan aerogel comprising CaO, the pore volume per aerogel mass can be about 0.055-0.065, 0.058-0.065, 0.060-0.065, 0.055-0.063, 0.058-0.063, or 0.060-0.063 cm³/g. In some aspects of an alpha-glucan aerogel comprising MgO, the pore volume per aerogel mass can be about 0.082-0.092, 0.085-0.092, 0.082-0.090, or 0.085-0.090 cm³/g. A neat alpha-1,3-glucan aerogel in some aspects has a pore volume per aerogel mass of about 0.075 cm³/g. The pore volume of an aerogel can be measured using any suitable method, such as that disclosed in the below Examples. The foregoing pore volume/mass values can optionally characterize hybrid alpha-glucan aerogels having about 2 wt % of the listed metal oxide.

In some aspects of an alpha-glucan aerogel comprising TiO₂, the specific surface area can be about 75-90, 78-90, 80-90, 75-85, 78-85, or 80-85 m²/g. In some aspects of an alpha-glucan aerogel comprising CaO, the specific surface area can be about 30-40, 35-40, 30-38, or 35-38 m²/g. In some aspects of an alpha-glucan aerogel comprising MgO, the specific surface area can be about 48-58, 50-58, 48-55, or 50-55 m²/g. A neat alpha-1,3-glucan aerogel in some aspects has a specific surface area of about 44.7 m²/g. The specific surface area of a porous material such as an aerogel herein refers to the interstitial surface area of the voids and/or pores per unit mass of the porous material. The specific surface area of an aerogel can be measured using any suitable method, such as the Brunauer-Emmett-Teller (BET) measurement (e.g., per the below Examples). The specific surface area values can optionally characterize hybrid alpha-glucan aerogels having about 2 wt % of the listed metal oxide.

In some aspects, a composition/product comprises an aerogel that has been comminuted (i.e., particulated). An aerogel can optionally be provided in the form of a powder or other particulate form (e.g., grains, dust, granules, flakes). A method of producing an aerogel herein can optional further comprise a step of comminuting the aerogel, for example, such as by grinding, pulverizing, shaving, chopping, cutting, or other action that serves to comminute a solid). Aerogel particles in some aspects can be about, or at least about, 5, 10, 25, 50, 75, 100, 125, 150, 200, 300, 400, 500, 600, 700, 800, 900, 1000, 5-125, 5-250, 5-500, 5-1000, 50-125, 50-250, 50-500, 50-1000, 100-125, 100-250, 100-500, or 100-1000 micrometers in diameter or longest dimension.

An aerogel or hydrogel herein, or a composition comprising either of these, typically is biodegradable. Such biodegradability can be, for example, as determined by the Carbon Dioxide Evolution Test Method (OECD Guideline 301B, incorporated herein by reference), to be about, at least about, or at most about, 5%, 10%, 15%, 20%, 25%, 30%, 35%, 40%, 45%, 50%, 55%, 60%, 65%, 70%, 75%, 80%, 85%, 90%, 5-60%, 5-80%, 5-90%, 40-70%, 50-70%, 60-70%, 40-75%, 50-75%, 60-75%, 70-75%, 40-80%, 50-80%, 60-80%, 70-80%, 40-85%, 50-85%, 60-85%, 70-85%, 40-90%, 50-90%, 60-90%, or 70-90%, or any value between 5% and 90%, after 15, 30, 45, 60, 75, or 90 days of testing.

An aerogel is heat-resistant in some aspects. For example, an aerogel can withstand degrading when exposed to a temperature of about, or up to about, 210, 225, 250, 275, 300, 325, 350, 210-250, 225-250, 210-300, or 225-300° C. Such heat-resistance can regard an aerogel comprising about 1, 1.5, 2, 2.5, 3, 4, 1-4, 1-3, or 1.5-2.5 wt % of a metal oxide herein, for example; other metal oxide content levels disclosed herein are also contemplated. Heat degradation can be manifest as a loss in weight (e.g., of about, or at least about, 50, 60, 70, 80, or 90%) upon being exposed to a foregoing temperature for a period of about 0.5, 1, 2, 5, 10, 15, 30, or 60 minutes, for example. Heat degradation resistance of an aerogel herein can be measured using any suitable method such as, for example, the methodology disclosed in the below Examples.

In some aspects, a hydrogel or aerogel comprises water-insoluble alpha-glucan herein that has been crosslinked using one or more crosslinking agents. Examples of crosslinking agents herein include phosphoryl chloride (POCl₃), polyphosphate, sodium trimetaphosphate (STMP), boron-containing compounds (e.g., boric acid, diborates, tetraborates such as tetraborate decahydrate, pentaborates, polymeric compounds such as Polybor®, alkali borates), polyvalent metals (e.g., titanium-containing compounds such as titanium ammonium lactate, titanium triethanolamine, titanium acetylacetonate, or polyhydroxy complexes of titanium; zirconium-containing compounds such as zirconium lactate, zirconium carbonate, zirconium acetylacetonate, zirconium triethanolamine, zirconium diisopropylamine lactate, or polyhydroxy complexes of zirconium), glyoxal, glutaraldehyde, aldehyde, polyphenol, divinyl sulfone, epichlorohydrin, polyamide-epichlorohydrin (PAE), di- or poly-carboxylic acids (e.g., citric acid, malic acid, tartaric acid, succinic acid, glutaric acid, adipic acid), dichloro acetic acid, polyamines, 1,2,7,8-diepoxyoctane, diethylene glycol dimethyl ether (diglyme), diglycidyl ether (e.g., diglycidyl ether itself, ethylene glycol diglycidyl ether [EGDGE], 1,4-butanediol diglycidyl ether [BDGE], polyethylene glycol diglycidyl ether [PEGDE, such as PEG2000DGE], 1,6-hexanediol diglycidyl ether, neopentyl glycol diglycidyl ether, bisphenol A diglycidyl ether [BADGE]), and triglycidyl ether (e.g., trimethylolpropane triglycidyl ether). Still other examples of suitable crosslinking agents are described in U.S. Pat. Nos. 4,462,917, 4,464,270, 4,477,360, or 4799550, or U.S. Pat; Appl. Publ. No. 2008/0112907, which are each incorporated herein by reference. A crosslinking agent typically can dissolve in an aqueous caustic solvent herein and act to crosslink alpha-glucan molecules that are also dissolved in the caustic solvent. Such crosslinking typically is covalent; i.e., alpha-glucan molecules are chemically crosslinked with each other (via intermolecular crosslinks).

An aerogel of the present disclosure typically can absorb water or another aqueous liquid. Thus, in some aspects, an aerogel can further comprise water or another aqueous liquid, where such water or aqueous liquid was absorbed by the aerogel (e.g., such as would be produced when a product comprising the aerogel is used in a method herein of absorbing an aqueous liquid). In some aspects, such an aerogel is under an applied load (e.g., as below) (e.g., under compression).

An aqueous liquid in some aspects comprises an aqueous solution, such as a salt solution (saline solution). A salt solution can optionally comprise about, or at least about, 0.01, 0.025, 0.05, 0.075, 0.1, 0.25, 0.5, 0.75, 0.9, 1.0, 1.25, 1.5, 1.75, 2.0, 2.5, 3.0, 0.5-1.5, 0.5-1.25, 0.5-1.0, 0.75-1.5, 0.75-1.25, or 0.75-1.0 wt % of salt (such wt % values typically refer to the total concentration of one or more salts). Examples of a salt that can be used in an aqueous solution herein include one or more sodium salts (e.g., NaCl, Na₂SO₄). Other examples of salts include those having (i) an aluminum, ammonium, barium, calcium, chromium (II or III), copper (I or II), iron (II or III), hydrogen, lead (II), lithium, magnesium, manganese (II or III), mercury (I or II), potassium, silver, sodium strontium, tin (II or IV), or zinc cation, and (ii) an acetate, borate, bromate, bromide, carbonate, chlorate, chloride, chlorite, chromate, cyanamide, cyanide, dichromate, dihydrogen phosphate, ferricyanide, ferrocyanide, fluoride, hydrogen carbonate, hydrogen phosphate, hydrogen sulfate, hydrogen sulfide, hydrogen sulfite, hydride, hydroxide, hypochlorite, iodate, iodide, nitrate, nitride, nitrite, oxalate, oxide, perchlorate, permanganate, peroxide, phosphate, phosphide, phosphite, silicate, stannate, stannite, sulfate, sulfide, sulfite, tartrate, or thiocyanate anion. Thus, any salt having a cation from (i) above and an anion from (ii) above can be in an aqueous liquid as presently disclosed, for example.

An aqueous liquid that can be absorbed by an aerogel herein can have a viscosity of about, at least about, or less than about, 1, 5, 10, 15, 20, 25, 50, 75, 100, 125, 1-125, 1-100, 1-50, 1-25, 1-15, 1-10, 1-5, 5-125, 5-100, 5-50, 5-15, 5-25, or 5-10 centipoise (cps, cP), for example. The viscosity of an aqueous liquid herein can be as measured at any temperature between about 3° C. to about 80° C., for example (e.g., 4-30° C., 15-30° C., 15-25° C.), or any particular temperature disclosed herein for an aqueous composition. Viscosity typically is as measured at atmospheric pressure (about 760 torr) or a pressure that is ±10% thereof. Viscosity can be measured using a viscometer or rheometer, for example, and can optionally be as measured at a shear rate (rotational shear rate) of about 0.1, 0.3, 0.5, 1.0, 3, 5, 10, 50, 100, 200, 500, 0.1-500, 0.1-100, 1.0-500, or 1.0-100 s⁻¹ (1/s), or about 5, 10, 20, 25, 50, 100, 200, or 250 rpm (revolutions per minute), for example.

An aqueous liquid that can be absorbed by an aerogel herein can be at a temperature of about 3° C. to about 80° C., for example (e.g., 20, 25, 30, 35, 37, 40, 45, 4-30, 15-30, 15-25° C., 30-45, 30-40, 35-45, or 35-40° C.).

An aqueous liquid that can be absorbed by an aerogel herein can be a bodily fluid, urine, blood, blood serum, menstrual fluid, liquid fecal matter (e.g., diarrhea), bile, stomach acid/juice, vomit, amniotic fluid, breast milk, cerebrospinal fluid, exudate, lymph, mucus (e.g., nasal drainage, phlegm), peritoneal fluid, pleural fluid, pus, rheum, saliva, sputum, synovial fluid, sweat, tears, water, or saline, for example.

Absorption of an aqueous liquid herein can be gauged by measuring the water retention value (WRV) (or other like terms, such as water retention capacity or water uptake) of the aerogel, for example. WRV herein can be measured by any suitable means, such as via the methodology disclosed in U.S. Patent Appl. Publ. No. 2016/0175811 (e.g., Example 7 therein), which is incorporated herein by reference, or by any methodology disclosed in the below Examples. Briefly, the WRV of a material such as an aerogel herein can be calculated using the following formula: ((mass of wet material −mass of dry material)/mass of dry material)*100. WRV can be measured with respect to any aqueous liquid as presently disclosed, for example. Thus, while the term WRV (and like terms) contains the word “water”, it would be understood that WRV can be measured with regard to any type of aqueous liquid disclosed herein, such as an aqueous solution or a bodily fluid. Absorption of an aqueous liquid by an aerogel herein can optionally be gauged by measuring centrifugal retention capacity (CRC) as disclosed in the below Examples or in U.S. Pat. No. 8,859,758 (incorporated herein by reference), for example. Absorption herein can optionally be measured by determining absorption under load (AUL), such as via the methodology disclosed in U.S. Pat. No. 8,859,758 or EDANA (European Disposables and Non-woven Association) standard test WSP 242.2.R3 (12), which are both incorporated herein by reference, or as disclosed in the below Examples. An applied load herein can be a pressure that is above atmospheric pressure (i.e., above ~15 pounds-per-square-inch [psi]), and/or can be about, or at least about, 50, 75, 100, 125, 150, 200, 250, 500, 1000, 2500, 5000, 75-150, or 75-125 g, for example (e.g., pressure/weight as applied to an area of aerogel of about, or under about, 2, 4, 6, 8, 10, or 12 cm²).

An aerogel herein can have a WRV of about, or at least about, 1000, 1100, 1200, 1300, 1400, 1500, 1600, 1700, 1800, 1900, 2000, 2100, 2200, 2300, 2400, 2500, 1000-2500, 1200-2500, 1300-2500, 1400-2500, 1500-2500, 1800-2500, 1000-2200, 1200-2200, 1300-2200, 1400-2200, 1500-2200, 1800-2200, 1000-2000, 1200-2000, 1300-2000, 1400-2000, 1500-2000, or 1800-2000, for example. Any of these values can be with respect to WRV measured without an applied load, or under an applied load (e.g., as above). Any of the foregoing WRV values can be with respect to an aerogel that has been exposed (with or without an applied load) to an aqueous liquid (i.e., time to absorb) for a time of about, or at least about, 20, 30, 40, 50, 60, 70, 80, 90, 100, 110, 120, 60-120, 60-110, 60-100, 80-120, 80-110, or 80-100 seconds, for example.

A composition/product comprising an aerogel as presently disclosed can be in the form of, or comprised within, a personal care product, household care product (household product), medical product, pharmaceutical product, or industrial product, for example. In some aspects, a composition/product herein (e.g., any of the foregoing) can be an absorbent or superabsorbent product. A personal care product, household care product, medical product, pharmaceutical product, or industrial product in some aspects is optionally designed, at least in part, for handling aqueous liquid absorption.

Examples of personal care products and/or uses thereof in aqueous liquid absorption include absorbent personal hygiene products such as baby diapers, potty training pants/liners, incontinence products (e.g., pads, adult diapers), and feminine hygiene products (e.g., sanitary napkins/pads, tampons, interlabial products, panty liners). Thus, a personal care product in some aspects can be characterized as a personal care absorbent article that can be placed against or near the skin to absorb and contain a fluid discharged or emitted from the body. Examples of personal care products that can be adapted accordingly to take advantage of the absorbency of an aerogel material herein (e.g., replace or supplement originally used absorbent material in a product) are disclosed in WO1999/037261, U.S. Patent Appl. Publ. Nos. 2004/0167491, 2009/0204091, 2001/0014797, 2013/0281949, 2002/0087138, 2010/0241098, 2011/0137277 and 2007/0287971, and U.S. Pat. Nos. 4,623,339, 2,627,858, 3,585,998, 3,964,486, 6,579,273, 6,183,456, 5,820,619, 4,846,824, 4,397,644, 4,079,739, 8,987,543, 4,781,713, 5,462,539, 8,912,383, 3,749,094, 3,322,123, 4,762,521 and 5,342,343, all of which patent application and patent publications are incorporated herein by reference.

Examples of industrial products and/or uses thereof in aqueous liquid absorption include cable wrappings (e.g., wrappings for power or telecommunication cables); food pads (e.g., meat pads); agricultural and forestry applications such as for retaining water in soil and/or to release water to plant roots; fire-fighting devices; and cleanup of acidic or basic aqueous solutions spills. Examples of industrial products that can be adapted accordingly to take advantage of the absorbency of an aerogel material herein are disclosed in U.S. Patent Appl. Publ. Nos. 2002/0147483, 2006/0172048, 20050008737, 2008/0199577, 2012/0328723 and 2004/0074271, and U.S. Pat. Nos. 5,906,952, 7,567,739, 5,176,930, 6,695,138, 4,865,855, 7,459,501, 5,456,733, 9,089,730, 5,849,210, 7,670,513, 7,670,513, 5,683,813, 5,342,543, 4,840,734 and 4,894,179, all of which patent application and patent publications are incorporated herein by reference.

Examples of medical products and/or uses thereof in aqueous liquid absorption include wound healing dressings such as bandages and surgical pads; hospital bedding; sanitary towels/pads; controlled drug release devices; cell immobilization islets; three-dimensional cell culture substrates; bioactive scaffolds for regenerative medicine; stomach bulking devices; and disposal of controlled drugs. Examples of medical products that can be adapted accordingly to take advantage of the absorbency of an aerogel material herein are disclosed in WO1998/046159, U.S. Patent Appl. Publ. Nos. 2005/0256486, 20030070232 and 20040128764, and U.S. Pat. Nos. 6,191,341, 7,732,657, 4,925,453, 9,161,860, 3,187,747 and 5,701,617, all of which patent application and patent publications are incorporated herein by reference.

An absorption method is presently disclosed that comprises, at least, contacting a composition/product comprising an aerogel herein with an aqueous liquid-comprising composition, wherein the composition/product absorbs aqueous liquid from the liquid-comprising composition. An aqueous liquid-comprising composition can be any aqueous liquid disclosed herein, for example. Thus, in some aspects, an aerogel can further comprise water or an aqueous liquid (e.g., as disclosed herein); typically, the water or aqueous liquid has been absorbed by the aerogel. An aerogel that has absorbed water can either be under a load or no load, for instance. The amount of water or aqueous liquid comprised in an aerogel herein can be up to the amount (or range) that reflects the water absorption capacity (e.g., as disclosed herein) of the aerogel, for example.

Some aspects of the present disclosure concern a caustic solution (an aqueous caustic solution) comprising at least (i) an aqueous caustic solvent, (ii) a water-insoluble alpha-glucan, and (iii) a metal hydroxide, wherein at least about 50% of the glycosidic linkages of the water-insoluble alpha-glucan are alpha-1,3 glycosidic linkages, wherein the water-insoluble alpha-glucan is dissolved in the aqueous caustic solvent and the metal hydroxide is not dissolved in (i.e., is insoluble in) the aqueous caustic solvent, and wherein the metal hydroxide is calcium hydroxide [Ca(OH)₂], magnesium hydroxide [Mg(OH)₂], or titanium hydroxide [Ti(OH)₄](or any other hydroxide of an alkali earth metal or transition metal, which metal hydroxide is suitable for producing a hydrogel of alpha-1,3-glucan using an aqueous caustic solution herein). The water-insoluble alpha-glucan component of a caustic solution herein can be as presently disclosed; for example, it can have a molecular weight (e.g., DP, DPw, or DPn) and/or glycosidic linkage profile as disclosed herein for an water-insoluble alpha-glucan.

A metal hydroxide in some aspects can be calcium hydroxide [Ca(OH)₂], magnesium hydroxide [Mg(OH)₂], or titanium hydroxide [Ti(OH)₄]. It is contemplated that a metal hydroxide herein can be another type of alkali earth metal hydroxide or transition metal hydroxide, for example, which metal hydroxide is suitable for forming a hydrogel using an aqueous caustic solution herein. Typically, an aqueous caustic solution or hydrogel herein has one metal hydroxide, but in some cases it can have two or more metal hydroxides [e.g., Ca(OH)₂ and Mg(OH)₂, Ca(OH)₂ and Ti(OH)₄, Mg(OH)₂ and Ti(OH)₄]. A metal hydroxide herein, as comprised in an aqueous caustic solution herein typically is not dissolved in (i.e., it is insoluble in) the caustic solvent; thus, an aqueous caustic solution herein can also optionally be characterized as an “aqueous caustic liquid composition” or other like terms.

An insoluble metal hydroxide of an aqueous caustic solution can be provided therein by adding a corresponding salt (salt precursor of the metal hydroxide) to the caustic solution of the disclosure. For example, MgCl₂·6H₂O, CaCl₂·2H₂O, or Ti[OCH(CH₃)₂]₄ inorganic salt can be added to provide insoluble Mg(OH)₂, Ca(OH)₂, or Ti(OH)₄; these hydroxides precipitate (become undissolved) given the elevated pH of the solution. A salt, to be added to an aqueous caustic solution, can be provided as an aqueous solution of the salt, for example. In some aspects, undissolved metal hydroxide can be provided in an aqueous caustic solution herein before introduction of insoluble alpha-glucan thereto.

An aqueous caustic solution or hydrogel herein can comprise an amount of metal hydroxide that is sufficient to provide an aerogel comprising a given amount of corresponding metal oxide (e.g., as disclosed herein) following the removal of water from a hydrogel (when producing the aerogel). In some aspects, the balance of the mass of an aqueous caustic solution or hydrogel is of (i) water-insoluble alpha-glucan and (ii) water or aqueous solution (i.e., such an aqueous caustic solution or hydrogel can be characterized as consisting of metal hydroxide, water-insoluble alpha-glucan, and water/aqueous solution) (when referring to a caustic aqueous solution, it typically further includes an alkali hydroxide [e.g., an alkali metal hydroxide such as NaOH, KOH, or LiOH]). However, in some aspects, an aqueous caustic solution or hydrogel can comprise one or more other components. An aqueous caustic solution or hydrogel can comprise about, or at least about, 3, 5, 6, 7, 8, 9, 10, 12, 14, 3-9, 4-8, or 5-7 wt % of water-insoluble alpha-glucan, in some aspects. An aqueous caustic solution or hydrogel in some aspects does not comprise polyurethane or any other organic polymer (aside for the insoluble alpha-glucan), and/or does not comprise silica. It is noted that an aqueous caustic solution of the foregoing disclosure can be that which is provided when performing a method herein of producing an aerogel or hydrogel.

An aqueous caustic solvent herein typically can dissolve an aqueous-insoluble alpha-glucan as presently disclosed. An aqueous caustic solvent can comprise an alkali hydroxide, for example. An alkali hydroxide can comprise at least one metal hydroxide (e.g., NaOH, KOH, LiOH) or organic hydroxide (e.g., tetraethyl ammonium hydroxide). An aqueous caustic solvent can be as disclosed, for example, in Int. Pat. Appl. Publ. Nos. WO2015/200612 or WO2015/200590, or U.S. Pat. Appl. Publ. Nos. 2017/0208823 or 2017/0204203, which are each incorporated herein by reference, or as disclosed in the below Examples.

In some aspects, an aqueous caustic solvent comprises one or more alkali hydroxides dissolved in water. The concentration of the alkali hydroxide(s) can be about or at least about, 2.5, 2.6, 2.7, 2.75, 2.8, 2.9, 3, 4, 5, 6, 7, 2.5-4, 2.5-3, 2.5-2.8, 2.6-4, 2.6-3, 2.6-2.8, 2.7-4, 2.7-3, 2.7-2.8, 3-5, or 3-4 wt %, for example.

The pH of an aqueous caustic solution herein and/or its aqueous caustic solvent can be about, or at least about, 11.0, 11.5, 12.0, 12.5, 12.75, 13.0, 13.25, 13.5, 13.75, 12.0-13.5, 12.0-13.0, 12.5-13.75, 12.5-13.5, 12.5-13.25, 12.5-13.0, 12.75-13.75, 12.75-13.5, 12.75-13.25, 12.75-13.0, 13.0-13.75, 13.0-13.5, 13.0-13.25, 13.25-13.75, or 13.25-13.5, for example. Such a pH can characterize an aqueous caustic solution before addition of an acid in some aspects. Yet, in some aspects, such a pH can characterize an aqueous caustic solution after addition of an acid (e.g., for partial neutralization, where the pH is lowered to be closer to neutral, but not completely neutral). The temperature of an aqueous caustic solution herein can be about, or at least about, 1, 5, 10, 15, 20, 25, 30, 35, 40, 45, 50, 1-50, 1-45, 1-40, 1-35, 1-30, 1-25, 1-20, 15-50, 15-45, 15-40, 15-35, 15-30, 15-25, 15-20, 20-50, 20-45, 20-40, 20-35, 20-30, 20-25, 5-30, 10-30, 5-25, or 10-25° C., for example.

Some aspects of the present disclosure concern a method/process of producing a hydrogel or an aerogel, such as disclosed herein. Such a method can comprise at least:
(a) providing an aqueous caustic solution as disclosed herein,
(b) putting the aqueous caustic solution into a desired form,
(c) chemically or ionically modifying the aqueous caustic solvent (chemically or ionically modifying the caustic solution) such that the water-insoluble alpha-glucan and the metal hydroxide are undissolved in (i.e., are insoluble in) the solvent, whereby a hydrogel is produced, and, if preparing an aerogel,
(d) removing all of the water, or most of the water, from the hydrogel, whereby
an aerogel is produced.
   An aerogel or hydrogel herein can be as produced by an aerogel/hydrogel production method as presently disclosed, for example.

Step (a) of an aerogel/hydrogel production method is typically performed by providing an aqueous caustic solution as presently disclosed. Step (a) can comprise, for example, combining (mixing, introducing) a suitable salt (e.g., MgCl₂·6H₂O, CaCl₂·2H₂O, or Ti[OCH(CH₃)₂]₄) of (corresponding to) the metal hydroxide (salt precursor of the metal hydroxide) with an aqueous caustic solution in which the water-insoluble alpha-glucan is dissolved, typically wherein the salt is provided as dissolved in an aqueous solution, and the metal hydroxide precipitates out of solution upon being combined with the aqueous caustic solution. Alternatively, in some aspects, a salt can be added to an aqueous caustic solution before alpha-glucan has been added to the solution. Typically, the metal hydroxide precipitates (becomes undissolved) upon its corresponding salt being mixed into the elevated pH of an aqueous caustic solution. The amount of salt provided can be that which provides a metal hydroxide content as disclosed elsewhere herein, for example.

Step (b) of an aerogel/hydrogel production method herein (i.e., putting the aqueous caustic solution into a desired form) can comprise, for example, placing/pouring the aqueous caustic solution of step (a) into a form that has the shape desired for the aerogel/hydrogel product. Such a shape can be cubic, cuboidal, spherical, cylindrical, prism (e.g., shape is a triangular prism or polygonal prism), pyramidal (e.g., shape is a square-, triangle-, or polygon-based pyramid), conical, or any other three-dimensional shape. In some aspects, step (b) can comprise placing/pouring the aqueous caustic solution of step (a) into the form of a film, coating, layer, or sheet; such a form can have a thickness of about, or at least about, 1 mm, 5 mm, 10 mm, 50 mm, 100 mm, 500 mm, 1 mm, 5 mm, 1 cm, 5 cm, or 10 cm, for example. An aerogel or hydrogel product herein can be any of the foregoing shapes, for example. Optionally, an aerogel or hydrogel shape can be that which is cut out from a larger aerogel or hydrogel. While step (b) can be performed before step (c) of an aerogel/hydrogel production method herein, step (b) can optionally be performed at about the same time as, or shortly after commencing, step (c), but before hydrogel formation (see below disclosure).

Step (c) of an aerogel/hydrogel production method herein can comprise chemically or ionically modifying the aqueous caustic solvent (chemically or ionically modifying the aqueous caustic solution) such that the water-insoluble alpha-glucan and the metal hydroxide are undissolved in (i.e., are insoluble in) the solvent (i.e., the alpha-glucan comes out of solution; the metal hydroxide was already out of the solution per step [a]), whereby a hydrogel is produced. This can be conducted by a coagulation process and/or neutralization process or partial neutralization process, for example; step (c) typically comprises reducing the pH of the aqueous caustic solution to a pH that renders the water-insoluble alpha-glucan to be undissolved in the solvent. Typically, step (c) is used to allow the form/shape produced in step (b) to be free-standing. Step (c) in some aspects can be performed by mixing one or more acids into the aqueous caustic solution, such as a weak acid (e.g., acetic acid, citric acid) or a strong acid (e.g., sulfuric acid). In some aspects, the amount of acid added would result in an acid concentration of about 0.008, 0.010, 0.012, 0.0125, 0.013, 0.014, 0.015, 0.020, 0.025, 0.030, 0.040, 0.050, 0.075, 0.10, 0.25, 0.50, 1, 2.5, 5, 0.008-0.020, 0.008-0.015, 0.010-0.020, 0.010-0.015, or 0.01-0.014 wt % (where such wt % would occur if the acid was not consumed during the ensuing neutralization). The pH resulting from performing neutralization such as a partial neutralization can be any of those pH values/ranges as listed above for an aqueous caustic solution, for example. In some aspects, such as in partial neutralization, the pH reduction is by no more than 0.25, 0.3, 0.35, 0.4, 0.45, or 0.5. The temperature at which step (c) is conducted can be any temperature as listed above for an aqueous caustic solution, for example. The amount of time for neutralization or partial neutralization to occur (e.g., starting from when a neutralizing agent such as an acid is added, up to the time of hydrogel formation) can be for about, or at least about, 2, 3, 6, 12, 24, 36, 48, 60, 72, 84, or 96 hours, for example. Typically, following adequate mixing of neutralizing agent with the solution, the solution is kept still during formation of the hydrogel (e.g., no agitation is applied to the solution [purposely or not], such as orbital rotation). As disclosed above, step (b) can optionally be performed simultaneously with, or shortly after commencing step (c), but before the hydrogel forms. For example, within a short time (e.g., about 1, 2, 5, 10, 15, or 20 minutes) of mixing a neutralizing agent such as acid into the solution, the solution can be placed into a desired form. In some aspects, coagulation and/or neutralization in step (c) can be performed as described in U.S. Patent Appl. Publ. No. 2016/0177471, 2016/0333157, 2017/0283568, or 2015/0191550, or U.S. Pat. No. 7,000,000 or 11098334, which are incorporated herein by reference, or as disclosed in the below Examples (e.g., where each condition/parameter is conducted within 5%, 10%, or 15% of the relevant condition/parameter disclosed in the Examples).

A hydrogel formed in step (c) typically can be isolated. For example, a hydrogel can be washed, such as with water or a suitable polar organic solvent (e.g., alcohol such as ethanol) (with or without added water). If desired, washing can be done until a neutral pH (e.g., pH 6-8, or ~7) (of the wash) is achieved. Washing, or a post-washing step, can optionally further include bathing the hydrogel in a 1-10 wt % (e.g., ~5 wt %) plasticizer (e.g., glycerol or ethylene glycol) solution (e.g., water- or alcohol-based) for a suitable period of time (e.g., at least 2, 3, or 4 minutes). A hydrogel can optionally be stored in water or a suitable polar organic solvent solution (e.g., alcohol such as ethanol) (with or without added water). While a “hydrogel” containing liquid that has no water technically is not a hydrogel per the above definition, such a composition is referred to as a “hydrogel” herein for ease of reference.

Step (d) of the foregoing production method can be performed if an aerogel is desired (to be made using the hydrogel product of step [c]). Step (d) can comprise removing all of, or most of (e.g., at least 97%, 98%, 99%, 99.5%, or 99.9% by weight of) the residing liquid (typically water and/or any other suitable liquid such as a polar organic solvent, with or without added water) from the hydrogel, thereby producing an aerogel. Removal of residing liquid from a hydrogel can be performed, for example, in such a way that the structure of the hydrogel is not substantially changed/altered. For example, residing liquid can be removed in a manner that substantially preserves the nano- and/or micro-structure (structure as observed on a nanometer or micrometer scale, respectively) of the hydrogel as it existed before removal of residing liquid therefrom. Substantial preservation of hydrogel structure in some aspects can be with respect to average pore size. For example, the average pore diameter of an aerogel from which residing liquid has been removed can be within (±) about 15%, 14%, 13%, 12%, 11%, 10%, 9%, 8%, 7%, 6%, 5%, 4%, 3%, 2%, or 1% of the average pore diameter as it had existed before removing the residing liquid (i.e., when it was a hydrogel). Average pore diameter can be measured as disclosed herein, for example.

Freeze-drying (lyophilization) and supercritical drying are examples of means herein for removing residing liquid from a hydrogel to produce an aerogel. Standard air drying means such as oven drying typically are not used herein for removing residing liquid from a hydrogel. Freeze-drying herein can be performed following the procedure listed in the disclosed Examples, for instance. In some aspects, freeze-drying can be performed at a temperature of about −120, −110, −105, −100, −90, −80, −70, −60, −50, −40, −80 to −120, −80 to −110, −90 to −120, −90 to −110, or −100 to −110° C., and/or for a time of about, or at least about, 1, 2, 6, 12, 24, 36, 48, 60, 72, or 84 hours under applied vacuum. A vacuum can be applied such that the pressure is less than about 400, 300, 200, 100, or 50 mTorr, for example; vacuum pressure can be at about 150-250, 175-225, or about 200 mTorr in some aspects. In some aspects, a hydrogel can first be normally frozen (e.g., about −20° C. at atmospheric pressure) before entry to freeze-drying processing. Supercritical drying can be performed using supercritical CO₂ (supercritical CO₂ drying), for example, such as disclosed in Int. Pat. Appl. Publ. No. WO2019/167013, or U.S. Pat. Appl. Publ. Nos. 2016/0058045, 2016/0068650, or 20130018112, which are incorporated herein by reference.

A composition/product comprising an aerogel or hydrogel as presently disclosed can be in the form of a household care product, personal care product, industrial product, medical product, or pharmaceutical product, for example, such as described in any of U.S. Pat. Appl. Publ. Nos. 2018/0022834, 2018/0237816, 2018/0230241, 20180079832, 2016/0311935, 2016/0304629, 2015/0232785, 2015/0368594, 2015/0368595, 2016/0122445, 2019/0202942, or 2019/0309096, or Int. Pat. Appl. Publ. No. WO2016/133734, which are all incorporated herein by reference. In some aspects, a composition/product comprising an aerogel or hydrogel herein can comprise at least one component/ingredient of a household care product, personal care product, industrial product, medical product, or pharmaceutical product as disclosed in any of the foregoing publications and/or as presently disclosed.

Non-limiting examples of compositions and methods disclosed herein include:
1. A composition (product) comprising at least an aerogel (or foam/solid foam, or sponge/solid sponge), wherein the aerogel comprises at least a water-insoluble alpha-glucan and a metal oxide, wherein at least about 50% of the glycosidic linkages of the insoluble alpha-glucan are alpha-1,3 linkages, and wherein the metal oxide is calcium oxide (CaO), magnesium oxide (MgO), or titanium dioxide (TiO₂) (or any other suitable oxide of an alkali earth metal or transition metal).
2. The composition of embodiment 1, wherein at least about 90% of the glycosidic linkages of the water-insoluble alpha-glucan are alpha-1,3 glycosidic linkages.
3. The composition of embodiment 1 or 2, wherein the water-insoluble alpha-glucan has a weight-average degree of polymerization (DPw) of at least about 10.
4. The composition of embodiment 1, 2, or 3, wherein the DPw is at least about 400.
5. The composition of embodiment 1, 2, 3, or 4, wherein the metal oxide is the titanium dioxide (TiO₂).
6. The composition of embodiment 1, 2, 3, 4, or 5, wherein the aerogel comprises less than about 20 wt % (or less than about 10 wt % or 8 wt %) of the metal oxide, optionally wherein the balance of the mass of the aerogel is of the water-insoluble alpha-glucan.
7. The composition of embodiment 1, 2, 3, 4, 5, or 6, wherein the metal oxide interacts with the water-insoluble alpha-glucan via hydrogen bonding.
8. The composition of embodiment 1, 2, 3, 4, 5, 6, or 7, wherein the aerogel has been comminuted (e.g., comminuted to particles such as of a powder) (i.e., particulated).
9. The composition of embodiment 1, 2, 3, 4, 5, 6, 7, or 8, wherein the aerogel further comprises water or an aqueous liquid, typically wherein the water or aqueous liquid was absorbed by the aerogel, optionally wherein the aerogel is under load.
10. The composition of embodiment 1, 2, 3, 4, 5, 6, 7, 8, or 9, wherein the composition is a personal care product, household care product, medical product, pharmaceutical product, or industrial product, and/or the composition is an absorbent product (e.g., a personal care product, household care product, medical product, pharmaceutical product, or industrial product that can absorb an aqueous liquid).
10a. The composition of embodiment 1, 2, 3, 4, 5, 6, 7, 8, 9, or 10, wherein the aerogel is produced by the method of embodiment 15, 16, 17, 18, or 19.
11. A caustic solution (an aqueous caustic solution) comprising at least (i) an aqueous caustic solvent, (ii) a water-insoluble alpha-glucan, and (iii) a metal hydroxide, wherein at least about 50% of the glycosidic linkages of the water-insoluble alpha-glucan are alpha-1,3 glycosidic linkages, wherein the water-insoluble alpha-glucan is dissolved in the aqueous caustic solvent and the metal hydroxide is not dissolved in (i.e., is insoluble in) the aqueous caustic solvent, and wherein the metal hydroxide is calcium hydroxide, magnesium hydroxide, or titanium hydroxide (or any other hydroxide of an alkali earth metal or transition metal, where such hydroxide is insoluble in the aqueous caustic solvent).
12. The caustic solution of embodiment 11, wherein at least about 90% of the glycosidic linkages of the water-insoluble alpha-glucan are alpha-1,3 glycosidic linkages.
13. The caustic solution of embodiment 11 or 12, wherein the water-insoluble alpha-glucan has a weight-average degree of polymerization (DPw) of at least about 10 (or at least about 400).
14. The caustic solution of embodiment 11, 12, or 13, wherein aqueous caustic solvent comprises at least one alkali hydroxide (e.g., an alkali metal hydroxide such as NaOH, KOH, or LiOH).
15. A method/process of producing an aerogel (e.g., according to embodiment 1, 2, 3, 4, 5, 6, 7, 8, or 9), the method comprising: (a) providing a caustic solution (aqueous caustic solution) according to embodiment 11, 12, 13, or 14, (b) putting the caustic solution into a desired form, (c) chemically or ionically modifying the aqueous caustic solvent (chemically or ionically modifying the caustic solution) such that the water-insoluble alpha-glucan and the metal hydroxide are undissolved in (i.e., are insoluble in) the solvent, whereby a hydrogel is produced (optionally, step [c] can be performed before or simultaneously to performing step [b]), and (d) removing all of the water, or most of the water (e.g., at least 98%, 99%, 99.5%, or 99.9% by weight of the water), from the hydrogel, whereby an aerogel is produced.
16. The method of embodiment 15, wherein step (a) comprises combining (mixing, introducing) a salt of the metal hydroxide (salt precursor of the metal hydroxide) with an aqueous caustic solution in which the water-insoluble alpha-glucan is dissolved, typically wherein the salt is provided as dissolved in an aqueous solution, and the metal hydroxide precipitates out of solution upon being combined with the aqueous caustic solution.
17. The method of embodiment 15 or 16, wherein step (c) comprises reducing the pH of the caustic solution to a pH that renders the water-insoluble alpha-glucan to be undissolved in the solvent (e.g., neutralization or partial neutralization of the solution, such as can be done by adding an acid) (in some aspects, the pH reduction is allowed to occur for a time of at least about 48 hours) (in some aspects, the pH reduction is by no more than 0.5).
18. The method of embodiment 15, 16, or 17, wherein step (c) further comprises keeping the solution still (e.g., no liquid agitation means such is/are applied) during formation of the hydrogel.
19. The method of embodiment 15, 16, 17, or 18, wherein step (d) comprises freeze-drying or supercritical drying the hydrogel (or any other process that removes the residual water/liquid in a manner that substantially preserves the nano-structure and/or micro-structure of the hydrogel as it existed before removal of the residual water/liquid) to form the aerogel.
20. An absorption method that comprises contacting a composition/product according to embodiment 1, 2, 3, 4, 5, 6, 7, 8, 9, 10, or 10a with an aqueous liquid-comprising composition, wherein the composition/product absorbs aqueous liquid from the aqueous liquid-comprising composition.

Non-limiting examples of compositions and methods disclosed herein include:
1b. A composition (product) comprising at least a hydrogel, wherein the hydrogel comprises at least a water-insoluble alpha-glucan and a metal hydroxide, wherein at least about 50% of the glycosidic linkages of the insoluble alpha-glucan are alpha-1,3 linkages, and wherein the metal hydroxide is calcium hydroxide [Ca(OH)₂], magnesium hydroxide [Mg(OH)₂], or titanium hydroxide [Ti(OH)₄](or any other hydroxide of an alkali earth metal or transition metal, wherein this metal hydroxide is suitable for forming a hydrogel of the water-insoluble alpha-glucan).
2b. The composition of embodiment 1b, wherein at least about 90% of the glycosidic linkages of the water-insoluble alpha-glucan are alpha-1,3 glycosidic linkages.
3b. The composition of embodiment 1b or 2b, wherein the water-insoluble alpha-glucan has a weight-average degree of polymerization (DPw) of at least about 10.
4b. The composition of embodiment 1b, 2b, or 3b, wherein the DPw is at least about 400.
5b. The composition of embodiment 1b, 2b, 3b, or 4b, wherein the metal hydroxide is the titanium hydroxide.
6b. The composition of embodiment 1b, 2b, 3b, 4b, or 5b, wherein the hydrogel comprises less than about 20 wt % (dry solids basis [dsb]) (or less than about 15 wt % dsb or 10 wt % dsb) of the metal hydroxide, optionally wherein the balance of the mass of the hydrogel on a dry solids basis is of the water-insoluble alpha-glucan.
7b-1. The composition of embodiment 1b, 2b, 3b, 4b, 5b, or 6b, wherein the composition is a personal care product, household care product, medical product, pharmaceutical product, or industrial product.
7b-2. The composition of embodiment 1b, 2b, 3b, 4b, 5b, 6b, or 7b, wherein the hydrogel is produced by the method of embodiment 12b, 13b, 14b, or 15b.
8b. A caustic solution (an aqueous caustic solution) comprising at least (i) an aqueous caustic solvent, (ii) a water-insoluble alpha-glucan, and (iii) a metal hydroxide, wherein at least about 50% of the glycosidic linkages of the water-insoluble alpha-glucan are alpha-1,3 glycosidic linkages, wherein the water-insoluble alpha-glucan is dissolved in the aqueous caustic solvent and the metal hydroxide is not dissolved in (i.e., is insoluble in) the aqueous caustic solvent, and wherein the metal hydroxide is calcium hydroxide, magnesium hydroxide, or titanium hydroxide (or any other hydroxide of an alkali earth metal or transition metal, where such hydroxide is insoluble in the aqueous caustic solvent).
9b. The caustic solution of embodiment 8b, wherein at least about 90% of the glycosidic linkages of the water-insoluble alpha-glucan are alpha-1,3 glycosidic linkages.
10b. The caustic solution of embodiment 8b or 9b, wherein the water-insoluble alpha-glucan has a weight-average degree of polymerization (DPw) of at least about 10 (or at least about 400).
11b. The caustic solution of embodiment 8b, 9b, or 10b, wherein aqueous caustic solvent comprises at least one alkali hydroxide (e.g., an alkali metal hydroxide such as NaOH, KOH, or LiOH).
12b. A method/process of producing a hydrogel (e.g., according to embodiment 1 b, 2b, 3b, 4b, 5b, 6b, or 7b), the method comprising: (a) providing a caustic solution (aqueous caustic solution) according to embodiment 8b, 9b, 10b, or 11b, (b) putting the caustic solution into a desired form, and (c) chemically or ionically modifying the aqueous caustic solvent (chemically or ionically modifying the caustic solution) such that the water-insoluble alpha-glucan and the metal hydroxide are undissolved in (i.e., are insoluble in) the solvent, whereby a hydrogel is produced (optionally, step [c] can be performed before or simultaneously to performing step [b]).
13b. The method of embodiment 12b, wherein step (a) comprises combining (mixing, introducing) a salt of the metal hydroxide (salt precursor of the metal hydroxide) with an aqueous caustic solution in which the water-insoluble alpha-glucan is dissolved, typically wherein the salt is provided as dissolved in an aqueous solution, and the metal hydroxide precipitates out of solution upon being combined with the aqueous caustic solution.
14b. The method of embodiment 12b or 13b, wherein step (c) comprises reducing the pH of the caustic solution to a pH that renders the water-insoluble alpha-glucan to be undissolved in the solvent (e.g., neutralization or partial neutralization of the solution, such as can be done by adding an acid) (in some aspects, the pH reduction is allowed to occur for a time of at least about 48 hours) (in some aspects, the pH reduction is by no more than 0.5).
15b. The method of embodiment 12b, 13b, or 14b, wherein step (c) further comprises keeping the solution still (e.g., no liquid agitation means is/are applied) during formation of the hydrogel.

Non-limiting examples of compositions in some alternative/auxiliary aspects include:
1. A composition (product) comprising about 35 to 65 wt % of a polyurethane, about 1 to 15 wt % of a water-insoluble alpha-glucan, and about 30 to 60 wt % of propanediol, wherein at least about 50% of the glycosidic linkages of the water-insoluble alpha-glucan are alpha-1,3 linkages, and typically wherein the composition is a dry solid material (the water-insoluble alpha-glucan can be as disclosed herein).
2. The composition of embodiment 1, wherein the composition is an elastomeric composition.
3. The composition of embodiment 1 or 2, wherein the composition is a foam.
4. The composition of embodiment 1, 2, or 3, wherein the composition is a molded composition/article (or a coating or film).
5. The composition of embodiment 1, 2, 3, or 4, wherein at least about 90% of the glycosidic linkages of the water-insoluble alpha-glucan are alpha-1,3 linkages.
6. The composition of embodiment 5, wherein about 100% of the glycosidic linkages of the water-insoluble alpha-glucan are alpha-1,3 linkages.
7. The composition of embodiment 1, 2, 3, 4, 5, or 6, wherein the weight-average degree of polymerization (DPw) of the water-insoluble alpha-glucan is about, or at least about, 400.
8. The composition of embodiment 7, wherein the DPw of the water-insoluble alpha-glucan is about, or at least about, 700 or 800.
9. The composition of embodiment 8, wherein the DPw of the water-insoluble alpha-glucan is about, or at least about, 1400 or 1600.
10. The composition of embodiment 1, 2, 3, 4, 5, 6, 7, 8, or 9, wherein the composition comprises about 3 to 7 wt %, 4 to 6 wt %, or 5 wt % of the water-insoluble alpha-glucan.
11. The composition of embodiment 1, 2, 3, 4, 5, 6, 7, 8, 9, or 10, wherein the composition comprises about 40 to 50 wt %, 42.5 to 47.5 wt %, or 45 wt % of the propanediol.
12. The composition of embodiment 1, 2, 3, 4, 5, 6, 7, 8, 9, 10, or 11, wherein the composition comprises about 40 to 60 wt %, 45 to 55 wt %, or 50 wt % of the polyurethane.
13. The composition of embodiment 1, 2, 3, 4, 5, 6, 7, 8, 9, 10, 11, or 12, wherein the composition comprises about 40 to 60 wt % (e.g., about 50 wt %) of the polyurethane, about 40 to 50 wt % (e.g., about 45 wt %) of the propanediol, and about 3 to 7 wt % (e.g., about 5 wt %) of the water-insoluble alpha-glucan.
14. The composition of embodiment 1, 2, 3, 4, 5, 6, 7, 8, 9, 10, 11, 12, or 13, wherein the polyurethane is a product of reacting a polyol with diisocyanate, optionally wherein, ratio-wise, about three parts of the polyol were reacted with about two parts of the diisocyanate to produce the polyurethane.
15. The composition of embodiment 1, 2, 3, 4, 5, 6, 7, 8, 9, 10, 11, 12, 13, or 14, wherein the polyurethane is any polyurethane as disclosed in U.S. Patent Appl. Publ. No. 2019/0225737, which is incorporated herein by reference.
16. The composition of embodiment 1, 2, 3, 4, 5, 6, 7, 8, 9, 10, 11, 12, 13, 14, or 15, wherein the composition comprises at least one additive (e.g., a pigment and/or abrasive) (e.g., any suitable additive as disclosed in International Patent Appl. Publ. No. WO2022/235655 or WO2023/183280, which are each incorporated herein by reference).
17. The composition of embodiment 1, 2, 3, 4, 5, 6, 7, 8, 9, 10, 11, 12, 13, 14, 15, or
16, wherein the composition is a consumer product or commercial/industrial product.
18. The composition of embodiment 1, 2, 3, 4, 5, 6, 7, 8, 9, 10, 11, 12, 13, 14, 15, 16, or 17, wherein the composition is footwear (e.g., a shoe or sneaker) or a component thereof (e.g., insole).
19. The composition of embodiment 1, 2, 3, 4, 5, 6, 7, 8, 9, 10, 11, 12, 13, 14, 15, 16, or 17, wherein the composition is a bedding, furniture, automotive interior, carpet underlay, or packaging, or any other product/article that typically contains polyurethane and/or a polyurethane foam.
20. The composition of embodiment 1, 2, 3, 4, 5, 6, 7, 8, 9, 10, 11, 12, 13, 14, 15, 16, 17, 18, or 19, wherein the composition has a compression set that is lower (e.g., about, or at least about, 25%, 30%, 40%, 50%, 60%, 70%, or 80% lower) than the compression set of a control composition that lacks the water-insoluble alpha-glucan (e.g., replaced with commensurate amount, wt %-wise, of propanediol) (e.g., the compression set can be about 8% to 20%, or about 8% to 15%, as measured using a suitable technique such as per ASTM D395, which is incorporated herein by reference).
21. The composition of embodiment 1, 2, 3, 4, 5, 6, 7, 8, 9, 10, 11, 12, 13, 14, 15, 16, 17, 18, 19, or 20, wherein the composition has a tear strength that is higher (e.g., about, or at least about, 100%, 200%, 300%, or 400% higher) than the tear strength of a control composition that lacks the water-insoluble alpha-glucan (e.g., replaced with commensurate amount, wt %-wise, of propanediol) (e.g., the tear strength can be about 3 to 7, or about 4 to 6, as measured using a suitable technique such as per ASTM D624, which is incorporated herein by reference).
22. The composition of embodiment 1, 2, 3, 4, 5, 6, 7, 8, 9, 10, 11, 12, 13, 14, 15, 16, 17, 18, 19, 20, or 21, wherein the composition has a tensile strength that is higher (e.g., about, or at least about, 10%, 20%, 30%, 40%, or 50% higher) than the tensile strength of a control composition that lacks the water-insoluble alpha-glucan (e.g., replaced with commensurate amount, wt %-wise, of propanediol) (e.g., the tensile strength can be about 10-14, or about 10-12, as measured using a suitable technique such as per ASTM D638, which is incorporated herein by reference).

### EXAMPLES

The present disclosure is further exemplified in the following Examples. It should be understood that these Examples, while indicating certain aspects herein, are given by way of illustration only. From the above discussion and these Examples, one skilled in the art can ascertain the essential characteristics of the disclosed embodiments, and without departing from the spirit and scope thereof, can make various changes and modifications to adapt the disclosed embodiments to various uses and conditions.

### Materials and Methods

Reagents: Calcium chloride dihydrate (CaCl₂·2H₂O, 99%, Fisher Chemical), sodium hydroxide (NaOH, 99%, EM Science), magnesium chloride hexahydrate (MgCl₂·6H₂O 99%, Sigma-Aldrich), titanium isopropoxide (Ti[OCH(CH₃)₂]₄, 99%, Sigma-Aldrich), acetic acid (99%, Sigma-Aldrich), sodium hydroxide (NaOH, 99%, EM Science) and absolute ethanol (78%, Sigma-Aldrich) were obtained from the respective suppliers and used without further preparation for their respective solution preparation. Deionized water collected from Milli-DI® a water purification system was used throughout this work.

Representative Preparation of Alpha-1,3-Glucan: Alpha-1,3-glucan with ~100% alpha-1,3 glycosidic linkages can be synthesized, for example, following the procedures disclosed in U.S. Appl. Publ. No. 2014/0179913 (see Example 12 therein, for example), which is incorporated herein by reference.

As another example, a slurry of alpha-1,3-glucan with ~100% alpha-1,3 glycosidic linkages was prepared from an aqueous solution (0.5 L) containing Streptococcus salivarius gtfJ enzyme (100 unit/L) as described in U.S. Patent Appl. Publ. No. 2013/0244288 (incorporated herein by reference), sucrose (100 g/L), potassium phosphate buffer (10 mM), and FermaSure® antimicrobial agent (100 ppm) adjusted to pH 5.5. The resulting enzyme reaction was maintained at 20-25° C. for 24 hours. A slurry was formed since the alpha-1,3-glucan synthesized in the reaction was aqueous-insoluble. The alpha-1,3-glucan solids were then collected using a Buchner funnel fitted with a 325-mesh screen over 40-micrometer filter paper.

The weight average degree of polymerization (DPw) of alpha-1,3-glucan used in this study was about 800.

Hybrid Alpha-1,3-Glucan Hydroqel and Aeroqel Preparation: Preparation of free-standing hybrid alpha-1,3-glucan hydrogels was performed using an acid-assisted co-precipitation method. Briefly, 0.6 g of alpha-1,3-glucan particles was dispersed in 10 mL of deionized water for 2 minutes, followed by the addition of 1 mL of 8 M NaOH solution. This preparation was kept under continuous stirring for 10 minutes until a clear solution was obtained; the pH of this solution (stock solution) was >13.35. 4.16 mL of this stock solution was added to the individual solutions of different inorganic salts (or to water only, for preparing neat solution); a pH of 13.13 was recorded for the neat alpha-1,3-glucan solution). From this approach, insoluble metal hydroxide was produced in situ via NaOH hydrolysis. A partial neutralization was then performed on each metal hydroxide/alpha-1,3-glucan preparation (or neat alpha-1,3-glucan solution) using 0.2 mL of 1% acetic acid solution (resulting in pH 12.9 for the neat alpha-1,3-glucan solution), which led to gelation by which free-standing hydrogels were obtained after 72 hours (hydrogel formation was allowed to occur with no agitation). Three different inorganic salts (MgCl₂·6H₂O, CaCl₂·2H₂O and Ti[OCH(CH₃)₂]₄) were used, respectively, as precursors for in situ generation of the metal hydroxides Mg(OH)₂, Ca(OH)₂ and Ti(OH)₄. MgCl₂·6H₂O and CaCl₂·2H₂O solutions were prepared by dissolving a specific amount of the salts in deionized water, before the alpha-1,3-glucan stock solution was added. For Ti(OH)₄ formation, a specific amount of Ti[OCH(CH₃)₂]₄ was hydrolyzed in ethanol before the alpha-1,3-glucan stock solution was added. Alpha-1,3-glucan hydrogels with different amounts of the metal hydroxides were produced, and a pure alpha-1,3-glucan control hydrogel (neat hydrogel) (no inorganic salt used) was also prepared for comparison. The hydrogels were thoroughly washed by soaking in deionized water until each hydrogel had a neutral pH. The hydrogels were then frozen at −20° C. for 4 hours followed by freeze-drying at −105° C. for 72 hours to obtain the final aerogels. Hybrid glucan aerogels with different levels of metal oxide were prepared (e.g., about 2 or 10 wt %); unless otherwise disclosed, hybrid glucan aerogels as studied below contained about 2 wt % of a metal oxide.

Rheology and Compressive Strength Assessments: Hydrogel strength measurement versus time was performed using a stress-controlled rotational rheometer (Anton Paar MCR-302) with a cone/plate geometry. Storage (G′) and elastic (G″) moduli were measured at a frequency of 1 Hz, temperature of 25° C., and 1.58% strain (y) value, within a linear viscoelastic envelope. A gap size of 1 mm was used to perform oscillatory strain sweep measurements at 25° C. A solvent-protecting cover was used to avoid dehydration of hydrogel samples during measurement. The same instrumental set up was used for examining the compressive strength of aerogels in dry form and after absorbing water. For each of the glucan aerogels prepared, cylindrical aerogels of similar height (~20 mm) and diameter (~16 mm) were used for compressive strength testing at a speed of 5 mm/min. For rheological measurement of each aerogels under water, the experiment was conducted by adding 10 mL of DI water into a cylindrical tube containing an aerogel of known weight. After 100 s, which is expected to be the maximum immersion time in this study for the aerogels to be saturated with water, the aerogel was removed from the water, excess water around its walls was dried-off with paper, and the rheological test was then performed. For each of the measurements, yield stress was considered as the end-point of the elastic region of the aerogels, while compressive Young's modulus was estimated from the stress-strain plot using the linear region of the normal force (N) versus time plot as given in Equations 1 and 2:

$$Stress = F / A , \qquad ( Eq . 1 )$$

where F is the normal force (N), and A is the area of a cylindrical sample.

$$Strain = Δ L / L , \qquad ( Eq . 2 )$$

where ΔL is the length of the stretch, and L is the original length.

Hydroqel Density Evaluation: The density (ρ) of each hydrogel was evaluated using Equation 3.

$$ρ = w / v , \qquad ( Eq . 3 )$$

where ρ is density, w is the weight of the cylindrical hydrogel, and v=pr²h (r is radius, and h is height).
   The weight of each sample was measured using a well-calibrated weighing balance with a readability of 0.0001 g, and the diameter and height were determined using an electronic digital caliper. Molders were used to prepare each hydrogel and aerogel sample to have a cylindrical shape for density measurement.

Confocal Laser Scanning Microscopy (CLSM): A Leica SP8 CLSM instrument was used to examine the internal structure and pore sizes of each hydrogel. An emission wavelength of 615 nm was selected for measuring the light reflection of glucan through which the hydrogels' structures were successfully unraveled. Images were acquired using an oil immersion objective (63×). The samples were dropped on a microscope slide and covered with another slide, and slightly pressed to remove trapped air. The samples were then imaged. The same instrument was used to collect the images of methylene-blue tagged aerogels, and the results were used to interpret the structural integrity of aerogels under water. In this regard, the samples were firstly tagged with methylene blue for 2 and 100 seconds, and the images were then collected using excitation and emission wavelengths of 668 and 688 nm for the methylene blue attached to the aerogels' walls.

Scanning Electron Microscopy (SEM): The surface morphologies of aerogels were examined using SEM (FEG 250 FESEM) using an accelerating voltage of 10 kV. The instrument was mounted with energy-dispersive X-ray spectroscopy (EDAX) for element map and analysis. Sample preparation was done by mounting the sample directly on a carbon tape attached to a sample holder. The images were collected at different magnifications of 1000×, 5000× and 100000× for examining open pores, wall thickness, and mesopores, respectively.

X-Ray Scattering: X-ray diffraction (XRD) spectra of aerogels were captured using a MINIFLEX600 X-ray diffractometer (Rigaku, Japan). The diffractograms were collected in the 20 range from 5 to 80° at a scanning rate of 1 (°)·min⁻¹ using monochromatic Cu Kα radiation (λ=0.1542 nm, voltage=40 kV, and current=15 mA). Crystallite sizes of the metal oxides (i.e., MgO, CaO, TiO₂) in the basal plane of each hybrid aerogel were determined from the diffraction peaks with highest intensity using the Debye-Scherrer relationship (Equation 4).

$$D = \frac{k λ}{{β}_{hkl} Cos {θ}_{hkl}} , \qquad ( Eq . 4 )$$

where k is the shape factor (0.9), λ is the X-ray wavelength (0.154 nm), βₕₖₗ is the full width at half maximum (FWHM), and θₕₖₗ is Bragg's angle.

Fourier Transform Infrared Spectroscopy (FTIR) Measurement: Fourier transform infrared spectroscopy (FTIR) spectra (400-4000 cm⁻¹) measurements were collected using a Cary 630 FTIR spectrometer, employing an attenuated transmittance accessory. The transmittances of the samples were collected against the background of the instrument for the data collection.

Nitrogen Porosity Measurement: Nitrogen adsorption-desorption measurements were performed in an instrument (GERMINI VII, Micromeritics) at of 77 K. Prior to the data collection, the aerogels were pretreated, and the instrument was degassed at 120° C. for 2 hours to remove any form of adsorbed moisture. The Brunauer-Emmett-Teller (BET) and Barrett-Joyner-Halenda (BJH) methods were used to estimate the specific surface area and pore volume of each sample.

Thermogravimetric Analysis (TGA): TGA was performed using an EXSTAR TG/DTA 6300 (SII NanoTechnology Inc.) instrument. The data were collected by heat-treating the aerogels starting from room temperature (RT, 20° C.) to 600° C. at a heating rate of 5° C./min under a nitrogen atmosphere (with flow rate of 100 mL). The working temperature of the TGA was kept between 2° and 600° C.

X-Ray Photoelectron Spectroscopy (XPS) Analysis: The chemical state of the elements in each samples was examined using an X-ray photoelectron spectroscope (XPS, VG ESCALAB 250, Thermo Scientific) calibrated based on C 1s at 284.4 eV. The sub-peak components obtained for each of the elements were assigned, in part, using a combination of CASAXPS software and Gaussian-Lorentzian functions.

Fluid Uptake and Retention Measurement: Three different model fluids were used to investigate the fluid uptake capacity of aerogels: DI water as a baseline, saline water as a model for urine, and glycerol/water as a model for menstrual fluid.

Experimental in-flow, fluid uptake and retention capacity were evaluated. In the first experiment, aerogels were tested without any load applied to their surface (“w/o load”). In the second experiment, a load was applied on top of each aerogel (i.e., under-load sorption experiment) and its fluid uptake performance was evaluated. The initial weight of each aerogel was measured using an analytical balance with readability of 0.0001 g. The aerogel was then placed into a container containing 10 mL of a model fluid. The soaked aerogel was then removed from the fluid, and excess fluid was removed with paper. The aerogel was allowed to stand on new paper for 5 minutes until all the fluid on its walls dried off, after which wet weight was measured. The fluid absorption capacity of each aerogel was calculated by subtracting the weight of the dry aerogel from its wet weight, dividing this difference by the dry weight, and multiplying by 100. An average value of three consecutive absorption capacity measurements was determined for each aerogel.

For determining fluid uptake and retention by each aerogel under load, a sintered glass filter plate (porosity=80 mm, h=7 mm) was placed in a cylindrical container of expanded polyethylene foam. A polyester gauze wire was then placed on the filter plate to separate the aerogel sample from the plate. The whole apparatus set-up was then placed into a Petri dish. A dried aerogel sample (10 mg) was placed on top of the surface of the polyester gauze wire. A cylindrical solid weight (stainless steel with weight of 100 g) was placed on the sample. Then, 10 mL of a fluid solution was added to the set-up. After different time intervals (2 to 100 seconds), each aerogel sample was removed and allowed to stand on paper for 5 minutes until all the surface water dried off. The absorption capacity of the sample was calculated as described above. An average value of three consecutive absorption capacity measurements was determined for each aerogel.

The centrifuge retention capacity (CRC) of each aerogel was measured as follows. A dry aerogel sample was soaked in a model liquid (10 mL). The soaked aerogel was then paper- and air-dried for 5 minutes followed by centrifuging (EPPENDORF 5810) the sample in a filter-fitted centrifuge tube. The weight of the centrifuged aerogel sample was taken at 400, 700, 2000 and 3000 rpm at different times. The CRC was then calculated using Equation 5:

$$CRC ( \frac{g}{g} \% ) = \frac{{w}_{CRC} - {w}_{o}}{{w}_{o}} \times 100 , \qquad ( Eq . 5 )$$

where w_{CRC} is the weight of the centrifuged aerogel, and wₒ is the weight of the dry aerogel. An average value of three CRC measurements was determined for each aerogel.

The kinetics related to the absorption capacity of the aerogels was studied using both pseudo-first and pseudo-second order rate laws. Equations 6 and 7, respectively, show the integrated form of the pseudo-first and second-order rate laws:

$$ln \frac{{Q}_{m}}{{Q}_{m} - {Q}_{t}} = {k}_{1} t \qquad ( Eq . 6 )$$

$$\frac{r}{{q}_{t}} = \frac{1}{{q}_{m}} t + \frac{1}{{k}_{2} {q}_{m}^{2}} \qquad ( Eq . 7 )$$

Qₘ or qₘ (g/g) is the maximum absorption capacity of an aerogels. Qₜ or qₜ (g/g) is the absorption capacity at a particular time. t is the time the aerogel spent in the container containing the DI water or other fluid. k₁ is the absorption rate constant for pseudo-first order and can be obtained as a slope of ln

$$( \frac{{Q}_{m}}{{Q}_{m} - {Q}_{t}} )$$

versus t plot (Eq. 6). k₂ is the absorption rate constant for pseudo-second order which is the inverse of the intercept×

$${q}_{m}^{2}$$

from the (t/qₜ) versus t plot (Eq. 7).

The hydrophilicity of the aerogels was examined. All the aerogels exhibited a contact angle of zero with water, thereby indicating that they were hydrophilic. To further unravel the variance in their hydrophilicity, aerogels of similar density were dropped into DI water, a perylene oil/water solution, or a perylene/canola oil/water solution, and their behaviors in each solution were compared.

### Results and Discussion

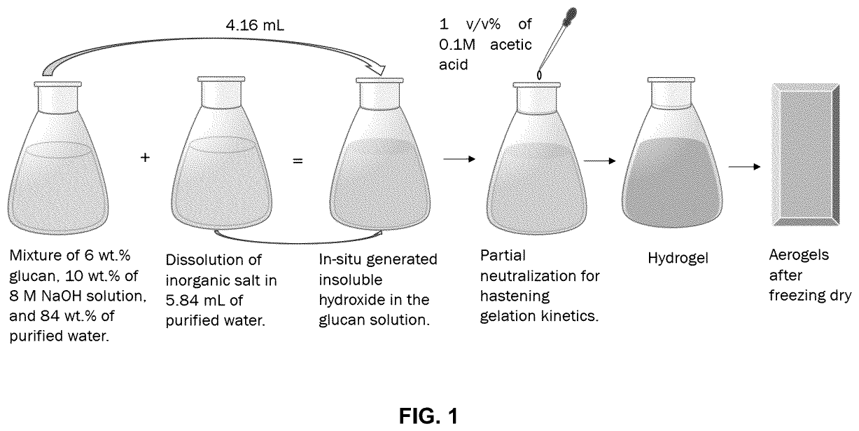

Materials Synthesis: Free standing hydrogels comprising metal hydroxide (Mg(OH)₂, Ca(OH)₂, or Ti(OH)₄) and alpha-1,3-glucan (hybrid hydrogels herein) were synthesized using precipitation methods through which the organization of glucan particles was successfully controlled using MgCl₂·6H₂O, CaCl₂·2H₂O, or Ti[OCH(CH₃)₂]₄ inorganic salt. FIG. 1 represents a typical scheme used herein for synthesizing hybrid hydrogels and hybrid aerogels. In the first steps (represented by the three left-most flasks in FIG. 1), a stock solution of 6 wt % alpha-1,3-glucan in aqueous NaOH (pH~13.45) was mixed with an inorganic salt solution to form a preparation of dissolved alpha-1,3-glucan and insoluble Mg(OH)₂, Ca(OH)₂, or Ti(OH)₂. The insoluble metal hydroxide was considered to interact with the dissolved alpha-1,3-glucan in this preparation via intermolecular hydrogen bonding. In the next steps (represented by the three right-most flasks in FIG. 1), an acetic acid solution was used to partially neutralize the preparation, beginning a gelation process to form a hydrogel of alpha-1,3-glucan and metal hydroxide. The hydrogel was washed with water, and then subjected to freeze-drying to form an aerogel. Thus, hybrid hydrogels were prepared comprising alpha-1,3-glucan and a metal hydroxide [Mg(OH)₂, Ca(OH)₂, or Ti(OH)₂], and hybrid aerogels were prepared comprising alpha-1,3-glucan and a metal oxide (MgO, CaO, or TiO₂). These materials are herein referred to as “hybrid hydrogels” and “hybrid aerogels”, as opposed to a “neat hydrogel”, which only has alpha-1,3-glucan.

Gelation Kinetics of Hydrogels: At 2 hours of standing, a neat alpha-1,3-glucan (2 wt %) solution without neutralization displayed no gelation due to relatively the high solubility of alpha-1,3-glucan at high pH>13.13. However, complete gelation was observed after 72 hours as the water content was reduced from removing the cap of the vial bottle containing the sample and exposing the sample to ambience. With that water removal, particle-particle physical interaction increased, and gelation began. Addition of 0.2 mL of 1% acetic acid to the alpha-1,3-glucan solution resulted in noticeable gelation after 2 hours, and formation of hydrogel with better stability at 72 hours. This suggested that the partial neutralization process aided gelation kinetics by precipitating solubilized alpha-1,3-glucan chains, which thus gave rise to quick interaction of the hydroxyl groups of the glucan particles for faster gelation.

Next, the pH was investigated at which gelation and hydrogel formation was favorable. It was found that hydrogel formation was mostly fast when the pH of the solution was kept between 12.80 and 13.0 where 80% to 90% of the particles were precipitated. Sulfuric acid and acetic acid were investigated for decreasing the pH, where a reasonably stable hydrogel of neat alpha-1,3-glucan was obtained at a pH of 12.98 and 12.91, respectively, after 2 hours of standing (no continued mixing/agitation was applied). Based on that, a pH of less than 13.0 was used for the preparation of hydrogels in this study. Introduction of 2 wt % inorganic salts (MgCl₂·6H₂O, CaCl₂·2H₂O, or Ti[OCH(CH₃)₂]₄) further increased the gelation rate where Ti(OH)₄/glucan, and Mg(OH)₂/glucan and Ca(OH)₂/glucan, were obtained at a pH of 12.96, and 12.86, respectively. The gelation of each inorganic salt/alpha-1,3-glucan solution started immediately, and stable hydrogels were formed at 30 minutes. This suggested that the in situ generated metal hydroxide [Mg(OH)₂, Ca(OH)₂, or Ti(OH)₄] improved particle-particle interaction for enhanced gelation.

The difference in the gelation kinetics of the hydrogels upon introduction of the inorganic salts was investigated by conducting oscillatory time sweep tests. The storage modulus (G′) and loss modulus (G″) for hybrid alpha-1,3-glucan hydrogels (2 wt % inorganic, dry solids basis [dsb][dsb is also referred to as dry weight basis, or dwb, herein]) and neat alpha-1,3-glucan hydrogel was evaluated. For the neat alpha-1,3-glucan hydrogel, the onset of storage modulus increase was seen after ~40 minutes of gelation time. In contrast, the hybrid compositions exhibited G′ increase immediately, but the slope of this growth differed. Ca(OH)₂/glucan exhibited a linear evolution of G′, while Ti(OH)₄/glucan and Mg(OH)₂/glucan exhibited nonlinear growth. None of these hydrogels reached a plateau within 60 minutes of gelation, indicating continuing microstructural evolution of the hydrogels. A nonmonotonic increase in G′ indicated that there was a strong interaction between the inorganics and alpha-1,3-glucan to form a non-covalent crosslinked structure. Interestingly, Mg(OH)₂/glucan hydrogel, followed by Ti(OH)₄/glucan and Ca(OH)₂/glucan hydrogels, exhibited larger G′ at the onset of gelation and proceeded with a larger rate of gelation, indicating more pronounced coupling between their constituent particles, resulting in fast formation of network.

Networking Structure of Hydrogels and Aerogels: To probe the microscopic origin of these significant differences in gelation kinetics, noninvasive imaging was conducted using reflectance mode of CLSM. For all of the samples, the images were collected at 2 hours of gelation time. The hydrogel of the neat alpha-1,3-glucan showed larger reflective domain sizes when compared to the hybrid glucan hydrogels, indicating a greater extent of aggregation between glucan particles in the neat alpha-1,3-glucan hydrogel. The introduction of metal hydroxide resulted in significantly different spatial distribution of particles, largely influenced by the ionic radius of the metal cation. The presence of Ca²⁺ with an ionic radius of 100 Å resulted in a hydrogel with open honeycomb structure, whereas Mg²⁺ and Ti⁴⁺ with smaller ionic radii of 72 Å and 61 Å, respectively, gave rise to hybrid hydrogels with a very dense particle network. These results were in agreement with the rheological response of these hydrogels. The dense Mg(OH)₂/glucan microstructure resulted in the highest modulus and fastest gelation kinetics, sequentially followed by those of the less dense Ti(OH)₄/glucan and least dense Ca(OH)₂/glucan microstructures.

The Brunauer-Emmett-Teller (BET) specific surface area for the neat glucan aerogel and selected hybrid (2 wt % inorganic) aerogels was evaluated. The TiO₂/glucan aerogel exhibited the highest BET specific surface area of 82.1058 m²/g, almost twice as high as the neat glucan aerogel. Given the smaller ionic radius and tetravalent nature of Ti⁴⁺ favor multidentate binding of TiO₂ to the glucan particle for the formation of smaller pore sizes and higher pore volume per aerogel mass (0.1371 cm³/g), such phenomenon could aid N₂ gas adsorption and desorption processes resulting in higher surface area. The effect of small ionic radius of metal for engineering small pore sizes and high pore volume (0.0883 cm³/g) was also revealed in the MgO/glucan aerogel with which a higher surface area of 53.3294 m²/g was obtained as compared to CaO/glucan aerogel (37.1272 m²/g). The CaO/glucan aerogel had larger pore sizes, and weak adsorption and retention of purged N₂ gas, resulting in smaller pore volume (0.0617 cm³/g). The surface area for the neat glucan aerogel was 44.6942 m²/g, while its pore volume was 0.0748 cm³/g.

Identification of Functional Groups of Hydrogels: To understand the functional groups in the hybrid and neat glucan hydrogels, FTIR was used for examining the chemical group of the samples. A specific amount (~5 mg) of each hydrogel was placed in a VERTEX 70 FTIR spectrometer, and the transmittance was collected against the background of instrument, i.e., copper plate sample holder. The FTIR spectra of the Ti(OH)₄-glucan hydrogels where in the O—H stretch vibration at 3282.62 cm⁻¹ decreased with increasing in the Ti[OCH(CH₃)₂]₄ salt loading, indicating glucan functionalization via intermolecular hydrogen bonding. The peaks at 2987.14 and 1635.29 could be associated to C—H and C—O stretch vibration of methylene and carbonyl groups respectively of the polysaccharide since they appear with similar intensity in the spectra of neat glucan hydrogels, and Ti(OH)₂-glucan hydrogels with different loading Ti[OCH(CH₃)₂]₄). However, the C—O bending mode of the neat glucan at 1044.32 cm⁻¹ appeared to be broad due to the intramolecular hydrogen bonding of the polysaccharide molecule. This peak became sharp with increasing intensity after introducing Ti[OCH(CH₃)₂]₄) because the in situ generated Ti(OH)₄ underwent intermolecular hydrogen bonding with the glucan molecule. New peaks appearing at 875.23 and 435.02 cm⁻¹ could be attributed to Ti—O—H and Ti—O—Ti interaction with increasing sharpness as the Ti[OCH(CH₃)₂]₄ loading increased. The increase in T-O—H vibration corresponded to a decrease in the O—H stretching mode, suggesting functionalization of glucan with Ti(OH)₄.

To confirm hydrolysis of the Ti[OCH(CH₃)₂ salt into Ti(OH)₄ in alcohol before it was introduced into glucan solution for hybrid hydrogel formation, a slight increase in pH from 5.94 to 7.34 was recorded. In addition, FTIR analysis was performed to confirm the hydrolysis of Ti[OCH(CH₃)₂]₄ to Ti(OH)₄. After the addition of alcohol to Ti[OCH(CH₃)₂]₄ and stirring for 10 minutes, a slight increase in the intensity of O—H stretching mode at 3360.0 cm⁻¹ was recorded, and there was formation of new O—H bending vibration at 1620.15 cm⁻¹, indicating hydrolysis. The disappearance of OCH(CH₃)₂ asymmetric and symmetric signal at 900 cm⁻¹ of Ti[OCH(CH₃)₂]₄, and formation of C—O stretching mode in the hydrolyzed Ti[OCH(CH₃)₂]₄, further indicated formation of Ti(OH)₄.

Different phenomena were observed with spectra of Mg(OH)₂-glucan and Ca(OH)₂-glucan hydrogels, where O—H and C—O stretching modes were found to be similar to that of neat glucan. The spectra with high magnification in the range of 1600 to 400 cm⁻¹ displayed where the C—O bending mode of the hybrid hydrogels shifted to lower wave number and the peaks gradually disappear with increasing the Ca or Mg salt (above) loading, suggesting glucan functionalization. Peaks at 424.07 cm⁻¹ signified Mg—O/Mg—O—Mg vibration, and the peak increased with increasing in the Mg salt loading. For the Ca(OH)₂-glucan hydrogel, the peak at 422.07 cm⁻¹ could be assigned to Ca—O/Ca—O—H vibration on the glucan, thus proving the functionalization of the glucan.

Hydroqel Density Characterization: The density of the hydrogels showed some effect on the properties of the aerogels. When compared to a neat glucan hydrogel, the hybrid hydrogels produced above displayed reasonable stability in water when the inorganic salt loading used in hydrogel production was <20 wt % (dsb); beyond that level, the hybrid hydrogels lost their mechanical strength and dispersed in water.

Furthermore, a noticeable lower hydrogel density was observed in water when the inorganic salt loading was more than 8 wt % (dsb), especially for the Ti(OH)₂-glucan hydrogels. For all of the hybrid hydrogels, there was an initial increase in the density with increasing the inorganic salt loading during hydrogel synthesis. Each of the hybrid hydrogels exhibited optimum density at different inorganic salt loading levels depending on the molecular weight of the metal. In particular, the optimum density of the Mg(OH)₂/glucan, Ca(OH)₂/glucan, and Ti(OH)₄/glucan hydrogels was found to be at 3 wt %, 8 wt %, and 2 wt % (all dsb) of the inorganic loading, respectively. At 2 wt % (dsb) inorganic salt loading, Mg(OH)₂-glucan, Ca(OH)₂-glucan, and Ti(OH)₄-glucan hybrid hydrogels exhibited densities of about 964.2, 992.1, and 997.2 kg m³, respectively.

Crystalline Structure and Phase Analysis of the Aerogels: XRD analysis was used to investigate the crystal structure of the hybrid and neat glucan aerogels. The neat aerogel exhibited a hexagonal crystal phase corresponding to the JCPDS number (No.) 48-1206. In the crystal structure, three diffraction peaks that were prominent appeared at 20 degree and crystalline plane of 9.6°, 18.1° and 21.9°. This indicated high crystallinity of the neat aerogel, and the average crystallite size was found to be 71.6 nm.

Hybrid aerogels retained nanocrystalline structures, and the metals (inorganics) took the crystal pattern of the glucan by showing hexagonal structure. The inorganics in the hybrid aerogels were in oxide forms according to the XRD analysis suggesting that the freeze-drying transformed the metal hydroxides (of the hydrogels) into metal oxides through water removal. In the crystal structure of the TiO₂-glucan aerogel, the TiO₂ peaks matched well with the JCPDS of card No. 33-1381. The major peaks of the TiO₂ were found at 31.5°, 33.5°, 37.2°, 39.0°, 55.1°, 57.2°, and 61.3° with a crystalline plane of (0 0 2), (2 1 1), (3 0 1), (2 2 0), (4 1 1), (2 1 3), and (4 2 0), respectively. Using the Scherrer equation, the average crystallite size of the TiO₂ was calculated to be 34.4 nm. The smaller crystallite size aids the growth of TiO₂ nanocrystals in the glucan network.

In addition to the crystalline planes of polymorphs of glucan, CaO-glucan aerogel exhibited extra peaks at 24.1°, 26.7°, 29.7°, 35.5°, 39.4°, 43.2°, 47.5°, and 48.3° assigned to CaO crystalline plane with JCPDS No. 28-0775. The average crystallite size of the CaO was found to be 43.1 nm.

The crystal structure of MgO-glucan aerogel had an extra peak corresponding to MgO and Mg(OH)₂ with JCPDS No. 30-0794 07-0239, respectively. The presence of the Mg(OH)₂ in the aerogel can be attributed to the hygroscopic nature of MgO. The major peak of the Mg(OH)₂ overlapped with MgO at 38.0° having a crystalline plane of (1 0 1) suggesting in situ conversion of the MgO to Mg(OH)₂ under ambient conditions after removing the aerogel product from the freeze-dryer. Mg(OH)₂ has other crystalline planes of (0 0 1), (1 0 0), (1 0 2), (1 1 0), (1 1 1), (1 0 3), and (2 0 0), while MgO exhibits crystalline planes of (4 0 0), (5 1 1), and (4 4 0). The average crystallite size of the Mg(OH)₂ and MgO in the MgO-glucan aerogel were found to be 31.5 and 29.2 nm, respectively.

The hybrid aerogels as prepared above had 0.5, 2, or 10 wt % of TiO₂, CaO, or MgO/Mg(OH)₂. For all of the hybrid aerogels, increase in the metal oxide component (and hydroxide component if Mg) changed the crystallinity and crystallite sizes of the glucan. When the metal component was >2 wt % of the hybrid aerogel, high crystallinity was recorded and the crystalline plane at 9.6° shifted to 10.4°, indicating a dehydrated form of the glucan. This clearly demonstrated that controlling the concentration of the inorganic precursors (metal salts) enabled preparation of hybrid aerogels with controlled physicochemical properties. In short, the metal oxide/hydroxide component could be used to engineer the crystallite size and interlayer distance of alpha-1,3-glucan.

Morpholoqy and Elemental Composition of Aerogels: Neat aerogel and hybrid aerogels (2 wt % inorganics) were documented macroscopically and by SEM.

When compared to hydrogels cast in a cylindrical mold, the corresponding aerogels showed similar lengths, but a slight reduction in diameter of about 2.5%.

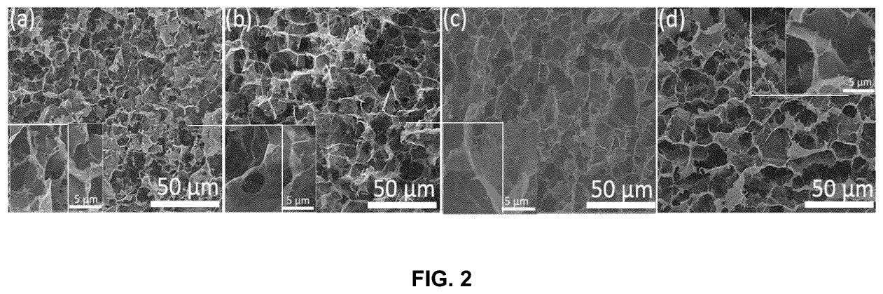

The surface structure and morphology of neat glucan aerogel and hybrid aerogels were revealed using SEM. SEM imaging showed that each aerogel exhibited a characteristic honeycomb microstructure with an open-porous surface in an interwoven network. The honeycomb microstructure of the neat glucan aerogel displayed a tear morphology along the growth direction of the hexagonal-like honeycomb microstructure (FIG. 2a). The open pores were ~10 to ~20 μm and appeared typically in between stacked layers of honeycomb structure with an average thickness of about 1.4 μm (FIG. 2a inset). The pore walls contained nanosheet structures with an average thickness of ~0.545 μm and randomly distributed nanopores of 50 to 250 nm diameter.

The hybrid aerogels exhibited changes in morphology in that unidirectional growth of microstructure with hexagonal prism shape was obtained (FIGS. 2a-d). The hybrid aerogels also showed less or no tear morphology as compared to the neat glucan aerogel. This indicates that the mechanical strengths of the hybrid aerogels were superior, which aids the unidirectionally undistorted growth of the honeycomb microstructure with hexagonal prism shapes. Other interesting features that were observed were an increase in the thickness of nanosheet layers of the honeycomb microstructure and smaller pore sizes of the nanosheet layer. The open pores existing between the interlayers of MgO-glucan aerogel nanosheets had an average size of ~8 μm (FIG. 2b), and the nanosheet layer had a thickness of 2.5 μm (inset of FIG. 2b). Furthermore, the pores of the nanosheet layer had a pore size in the range of 10 to 150 nm as measured along the x-axis direction.

The CaO-glucan aerogel exhibited similar phenomenon in that the open pore at the interlayer was ~8.5 μm (FIG. 2c), and the nanosheet thickness was 1.5 μm (inset of FIG. 2c); the pores at the nanosheet layer were in the range of 10 to 170 nm, which was slightly larger than the nanosheet layer pores of the MgO-glucan aerogel. This indicates that metal ionic radius might also play a role in the pore size arrangement similar to what was observed in the hydrogels. The greater reduction in open pore size and increase in the nanosheet layer could be attributed to the growth of the metal oxide along the basal plane of the glucan, which could be responsible for the higher mechanical strength observed in the hybrid hydrogels. However, amongst the hybrid aerogels, the TiO₂-glucan aerogel showed the smallest open pores and thickest nanosheet layer, which were found to be 7.8 μm (FIG. 2d) and 2.7 μm (inset of FIG. 2d), respectively; the pore size at the nanosheet layer was also found to be the smallest in the range of 5 to 140 nm. This suggests that the transition metal oxide, TiO₂, could exhibit multivalent hydrogen bonding with the glucan due to tetravalent nature of the Ti metal. This could also explain the superior mechanical strength observed in the Ti(OH)₄-glucan hydrogel.

EDS analysis was used for estimating the chemical compositions of the neat glucan and hybrid glucan aerogels. The major peaks appearing in the EDS spectra could be assigned to the elements in the aerogels. A good distribution of Ti was observed in the TiO₂-glucan aerogel, as compared to the distribution of Mg and Ca in the MgO-glucan and CaO-glucan aerogels, respectively. This can be attributed the tetravalent nature of the Ti which allow multivalent hydrogen bonding with glucan.

Identification of Functional Groups of Aerogels: The structures of both neat glucan and hybrid aerogels were further examined using FTIR spectroscopy to identify different functional groups in the materials. Neat glucan and hybrid aerogels exhibited similar FTIR spectra, except for the additional vibrational bands at the lower wave number of <500 cm⁻² in the hybrid aerogels. The extra peaks are characteristic vibrational bands of metal-oxygen-metal (M-O-M) signals. This shows that the molecular structure of the glucan is somehow retained after inclusion of the metal oxide.

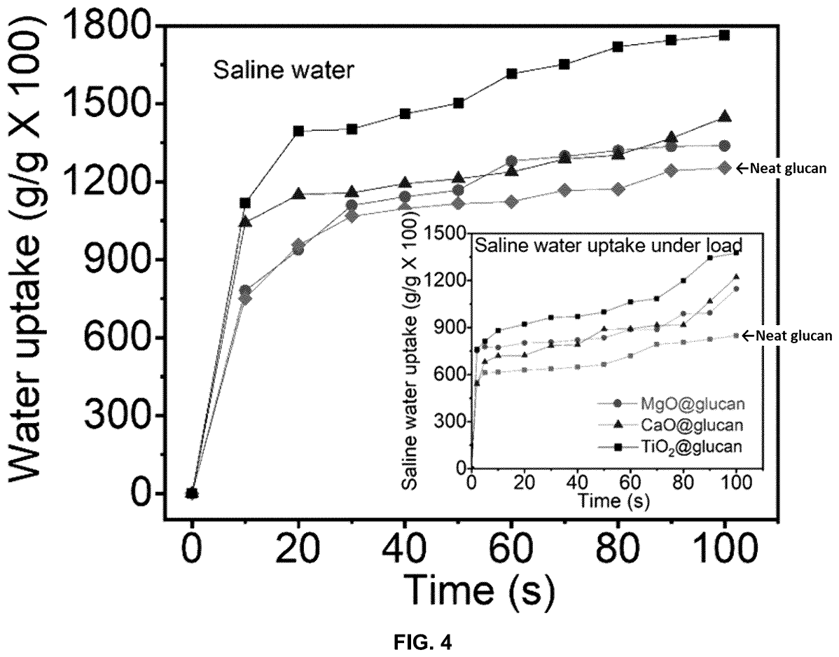

A detailed analysis in the region of 400 to 1600 cm⁻¹ revealed the detail of the vibration bands associated with metal oxides (FIG. 4b) in the hybrid aerogels. For the MgO-glucan aerogels, the additional peaks at 450.72 cm⁻¹ could be attributed to Mg═O/Mg—O—Mg signals, and the CaO-glucan aerogel has peaks at 430.19 cm⁻¹ assigned to Ca═O/Ca—O—Ca vibrational bands. TiO₂-glucan aerogels showed a vibrational peak at 431.19 cm⁻¹, which is the vibrational band for Ti—O—Ti/Ti═O interactions. Depending on the availability of the metal (“M”) species, the vibrational bands for the M=O/M-O-M species showed varied intensity among the hybrid aerogels. For example, the band intensity for Mg—O—Mg species was somewhat the highest as compared to Ca═O/Ca—O—Ca and Ti═O/Ti—O—Ti species at 2 wt % levels of the metal oxides in the hybrid aerogels. However, these peaks were almost absent in the case of neat glucan aerogel. This proves that both the neat glucan and hybrid aerogels were successfully synthesized via the co-precipitation method, while only the precursors for the intercalated metal oxides were changed.

Furthermore, based on FTIR analysis of hydrogels, it was expected that the O—H stretching bands of the hybrid aerogels should have different behavior as compared to neat glucan aerogel. This would further aid the understanding of the chemical interaction between glucan and metal oxide. To unravel this, the spectra of each aerogel in the region of 4000 to 3100 cm⁻¹ was expanded and carefully analyzed. The O—H stretching bands of the hybrid aerogels showed broader shape with reduced intensity of transmittance as compared to that of the neat glucan aerogel. These characteristics could be traced to the inclusion of metal oxide resulting in a disruption of intramolecular hydrogen bonding of glucan, and formation of intermolecular hydrogen bonding between the metal oxide and the glucan. Among the hybrid aerogels, the O—H stretching mode of TiO₂-glucan aerogel had the lowest intensity indicating superior chemical interaction and networking between TiO₂ and glucan. Moreover, the O—H stretching band of the CaO-glucan aerogel underwent a slight shift to a lower frequency region suggesting that Ca—C species might induce a wider interlayer distance between the crystal plane of the glucan similar to what was observed in the hydrogel analysis.

### Thermogravimetric Analysis (TGA) of Aerogels

The thermal stability of the neat glucan and hybrid glucan aerogels was examined using TGA, which was performed from 20 to 600° C. A heat resistance curve versus temperature of the aerogels was prepared, showing that the neat glucan aerogel exhibited an initial weight loss at a lower temperature as compared to the hybrid glucan aerogels (each of 2 wt % metal oxide). This indicates that aerogel composition influences thermal stability. For instance, an initial weight loss (~7%) of the neat glucan aerogel occurred at ~60° C. due to removal of surface moisture. Following that, a second weight loss (11%) of the neat glucan aerogel occurred at ~205° C. due to the removal of entrapped moisture within the structure. This gradual weight loss was not observed in the case of the hybrid aerogels (each of 2 or 10 wt % metal oxide), suggesting a better stability of the hybrid aerogels in the moisture-containing atmosphere. Only a 5% weight loss was observed at 260° C. for the hybrid aerogels (each of 2 wt % metal oxide), while this initial weight loss occurred at 175° C. for the hybrid aerogels having 10 wt % MgO or CaO. However, the initial weight loss of ~5% appeared at 210° C. for the hybrid aerogel having 10 wt % TiO₂.

The neat glucan aerogel exhibited a sharp weight loss (91%) beginning at 200° C. and ending at 420° C., which could be due to thermal degradation of the glucan. However, all of the hybrid aerogels containing 2 wt % metal oxide displayed superior heat-resistance curves where a sharp weight loss (~90%) was observed beginning at 250° C. and ending at 420° C. for all the samples. The remaining weight that was the inorganic phase was retained up to 475-600° C., depending on which metal oxide was present. In hybrid aerogels with 10 wt % metal oxide, different weight loss and lower heat-resistance was experienced. Sharp weight loss began at ~170° C. and ended between 350-380° C. depending on the metal oxide present.

Chemical and Surface-Mediated Properties of Aerogels: The functional group and surface-mediated properties of the aerogels were elucidated using XPS. Hybrid glucan aerogels (2 wt % metal oxide) were used for the XPS analysis since samples with higher metal oxide content displayed inferior thermal stability and structural integrity (see above TGA analysis). Both the neat glucan and hybrid glucan aerogels showed four prominent peaks, which could be assigned to oxygen (O) and carbon (C). However, an analysis of the spectra was performed to unravel the presence and chemical interaction of the metal oxide at the glucan surface. Peaks related to Mg 2p, Ca 2p and Ti 2p were detected on the MgO-glucan, CaO-glucan and TiO₂-glucan aerogels, respectively. These peaks together with that of O and C were deconvoluted to understand their chemical states. The sub-peak components in each of the elements were assigned using Gaussian-Lorentzian functions.

The deconvoluted peaks of oxygen in all of the aerogels were observed. The O 1s of the neat glucan aerogel showed two deconvoluted peaks located at ~529.87 and 530.29 eV, which could be assigned to C═O and O—C—O interactions in the polysaccharide structure. These peaks underwent a slight modification in the hybrid glucan aerogels in which C═O signal shifted to a higher binding energy of ~530.08, 530.07 and 530.08 eV for TiO₂-glucan, CaO-glucan and MgO-glucan aerogels, respectively. An increase in the intensity and coverage area of C═O signals was also observed in with the hybrid glucan aerogels. This was due to the presence of TiO₂, CaO, or MgO at the basal plane of the glucan, which resulted in an increase in the vibrational bands of C═O. This indicates surface functionalization of the glucan. Further, the O—C—O signals of the hybrid glucan aerogels appeared at the binding energy position (~530.29 eV) similar to that of the neat glucan aerogel, but with reduced intensity. This suggests that there was trade-off of intramolecular hydrogen bonding for intermolecular hydrogen bonding (there was increased hydrogen bonding between alpha-glucan hydroxyl groups and the metal oxide [i.e., intermolecular], and reduced hydrogen bonding between alpha-glucan hydroxyl groups [i.e., intramolecular]) after the surface functionalization with TiO₂, CaO and MgO. TiO2-glucan aerogel showed an additional peak at 530.20 eV corresponding to Ti—O interaction in the structure. For the CaO-glucan and MgO-glucan aerogels, the addition peaks could be found at 529.90 and 530.24 eV for Ca—C and Mg—O/Mg—(OH)₂ interaction, respectively.

The sub-components of the C 1s in the aerogels were observed. The C 1s peak of the neat glucan aerogel could be deconvoluted into three sub-peaks while that of the hybrid glucan aerogels could be deconvoluted into four sub-peaks. The three sub-components of the C 1s of the pristine glucan aerogel had peaks at 282.16, 283.83 and 285.20 eV assigned to C—C/C—H, C—O/C—OH and O—C—O/C═O signals, respectively. For the hybrid glucan aerogels, C—C signals showed lower area coverage and intensity. Among the hybrid glucan aerogels, the TiO₂-glucan aerogel showed a C—C signal with smallest area coverage and intensity. The area coverage of a C—C signal for the CaO-glucan and MgO-glucan aerogels were similar but slightly lower than that of the neat glucan aerogel. This suggests that the systematic placement of metal oxide at the backbone of glucan causes C—C signal reduction owing to the C—Ti, C—Ca, and C—Mg interaction at binding energy of 284.34, 284.37, and 284.27 eV for the TiO₂-glucan, CaO-glucan and MgO-glucan aerogels, respectively.

The XPS peaks of the metals in the hybrid aerogels showed poor resolution due to their amount and interlayer entrapment within the glucan structure. However, these peaks were carefully analyzed and deconvoluted into different sub-components. The Ti 2p peak could be deconvoluted into four sub-components where peaks at 455.77 and 461.57 eV were assigned to the Ti 2p_{3/2} and Ti 2p_{1/2} species of TiO₂ present in the TiO₂-glucan aerogels. The XPS analysis revealed that a trace Ti₂O₃ phase might be present in the sample with Ti 2p_{2/3} and Ti 2p_{1/2} having a binding energy at 457.69 and 464.17 eV, respectively. The Ca 2p peak of the CaO present in the CaO-glucan aerogel was deconvoluted into two peaks where the Ca 2p_{3/2} and Ca 2p_{1/2} species were found at 345.15 and 348.70 eV, respectively. The Mg 2p peak of the MgO-glucan aerogel was deconvoluted into two peaks at 47.74 and 49.98 eV which could be assigned, respectively, to the MgO and Mg(OH)₂ phases of the aerogel. All of these data indicate that the metal oxides were successfully dispersed in the structure of the glucan, thereby giving rise to functionalized glucan aerogels.

Rheological Properties of Aerogels: The mechanical properties such as yield stress and compressive modulus of the neat glucan and hybrid glucan aerogels were evaluated to determine their shock and wear resistance capacities. Aerogels in cylindrical form were used for in-plane compressive testing to obtain force (N) versus time (s) plots. Three distinct regions were observed from each plot: a linear (elastic) region, a plasticity region, and a densification region. The end of the elastic region is considered as yield stress (i.e., stress point at which the aerogels undergo permanent deformation). When compared to the neat glucan aerogel, the hybrid aerogels showed wider elastic regions with superior performance displayed by the TiO₂-glucan aerogel followed by the CaO-glucan and MgO-glucan aerogels. This indicated that the hybrid aerogels exhibited stronger resistance to cell wall bending at low strain.

To better understand the mechanical behaviors of the aerogels, a careful mechanical analysis based on a compressive stress-strain relationship was carried out. Compressive stress-strain curves were obtained using the elastic region, and the slope of the curves was considered as the compressive modulus. The hybrid glucan aerogels displayed ductile-like behaviors throughout the strain function, especially with the TiO₂-glucan aerogel. A stress-strain curve was obtained for the neat glucan aerogel showing a yield stress and compressive modulus of 0.0201 kPa and 0.0851 kPa, respectively. The presence of small pores and metal oxides in the microstructure of the hybrid glucan aerogels resulted in slightly improved mechanical strength. MgO-glucan aerogel exhibited a yield stress and compressive modulus of ~0.03055 kPa and 0.06706 kPa, respectively, while those for the CaO-glucan aerogel were found to be 0.03015 kPa and 0.06827 kPa, respectively. The TiO₂-glucan aerogel exhibited the highest ductile-like behaviors with up to 60% strain function at yield stress and compressive modulus of 0.04574 kPa and 0.08951 kPa, respectively. This indicated that the TiO2-glucan aerogel microstructure possessed the strongest networking.

The hybrid glucan aerogels were further shown to have superior mechanical properties over the neat glucan aerogel. The neat glucan aerogel was completely broken into pieces at a strain function of ~20% due to having a weak microstructure. MgO-glucan and TiO₂-glucan aerogels showed no cracks throughout the compression test. The only densification of the hybrid aerogels was observed at a higher strain function of >30% followed by deformation without any noticeable cracks. CaO-glucan aerogel displayed a noticeable crack around the cell wall at the strain function of >30%. This was due to larger nanopore sizes in the CaO-glucan aerogel as discussed above.

The mechanical strength of glucan aerogels was investigated after being subjected to water uptake for 100 s. This study was conducted by adding 10 mL of deionized water into a cylindrical tube containing a glucan aerogel with a known weight. After 100 s (this time is expected to be water uptake time to reach saturation), the aerogels were removed and dried at room temperature for 5 minutes followed by compressive testing. Compressive loading curves were prepared with each saturated aerogel. Similar to what was observed in dried form, the hybrid glucan aerogels exhibited slight increases in mechanical strength as compared to the glucan aerogel. This suggests that a moisture environment would have little or no effect on the hybrid aerogel compositions. However, a lower yield stress and compressive modulus were recorded due to the structure weakening under water. The yield stress and compressive modulus of the water-saturated neat glucan aerogel decreased to 0.00180 kPa and 5.67×10⁻⁵ kPa, respectively. MgO-glucan and CaO-glucan aerogels underwater exhibited yield stresses of 0.00210 kPa and 0.00277 kPa, and compressive moduli of 7.35×10⁻⁵ kPa and 9.38×10⁻⁵ kPa, respectively. Interestingly, compared to neat glucan aerogel, TiO₂-glucan aerogel under water exhibited a much greater increase in mechanical strength with a yield stress and compressive modulus of 0.00301 and 0.000301 kPa, respectively. This indicated that TiO₂ formed the strongest networking with glucan, which in turn contributed to the improved mechanical strength and structural integrity of this hybrid aerogel.

Fluid Uptake and Retention Performance: Water uptake and retention before and after compressive testing was studied with the neat glucan aerogel and hybrid glucan aerogels. Without compression, hybrid glucan aerogels exhibited a superior water uptake capacity (g/g×100) in the range of ~1340% to 1540% as compared to the neat glucan aerogel (water uptake capacity of ~1057%). After compression, the water retention capacity of each aerogel was found to be in the following order: neat glucan (980%)<MgO-glucan (1202%)<CaO-glucan (1247%)<TiO₂-glucan (1403%).

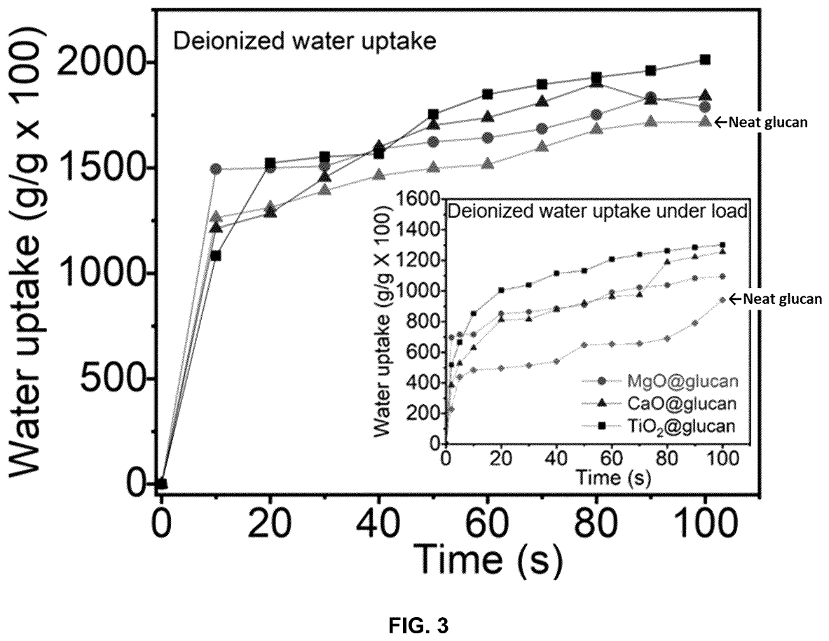

Each hybrid glucan aerogel exhibited improved water absorption capacity with increasing time as compared to neat glucan aerogel in an in-plane absorption assay (FIG. 3). Somewhat similar absorption capacities were observed for all the aerogels at <30 seconds. However, the TiO₂-glucan aerogel displayed a noticeably improved absorption capacity within the absorption time period of 40 to 100 seconds, while MgO-glucan and CaO-glucan aerogels only showed a marginal improvement as compared to the neat glucan aerogel by the 100 second time period. Specifically, at 100 seconds, the TiO₂-glucan aerogel exhibited a maximum water absorption capacity of ~20.0 g/g, while the MgO-glucan and CaO-glucan aerogels had a maximum water absorption capacity of about 17.9 g/g and the neat glucan aerogel had an absorption capacity of about 17.0 g/g. This showed that hybrid glucan aerogels, particularly TiO₂-glucan aerogel, with 2 wt % metal oxide could aid faster diffusion of water into an aerogel matrix.

The water absorption capacity of the aerogels under load was also investigated (FIG. 3 inset). Water absorption under load was conducted by placing a steel weight (~100 g) directly on the aerogel (~100 mg) in a cylindrical container. Each aerogel under load was allowed to stand for 100 seconds in the container with water. There was a modest drop in the absorption capacities of the glucan aerogels under load as compared to the aerogels without load. Among the aerogels under load, at 100 seconds, the TiO₂-glucan aerogel possessed the highest water uptake capacity (13.19 g/g), while the neat glucan, MgO-glucan and CaO-glucan aerogels were found to have water uptake capacities of 9.55, 11.19 and 12.82 g/g, respectively. The water absorption capacities of a commercial diaper and commercial sanitary pad under load were also measured, and found to be 43.18 and 13.90 g/g, respectively.

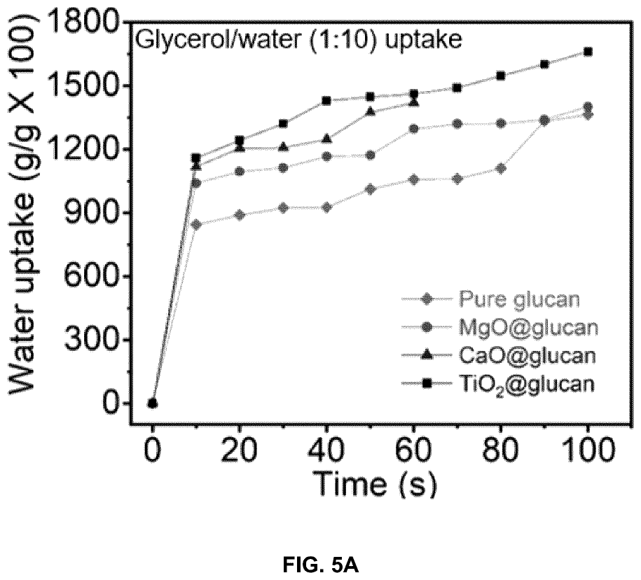

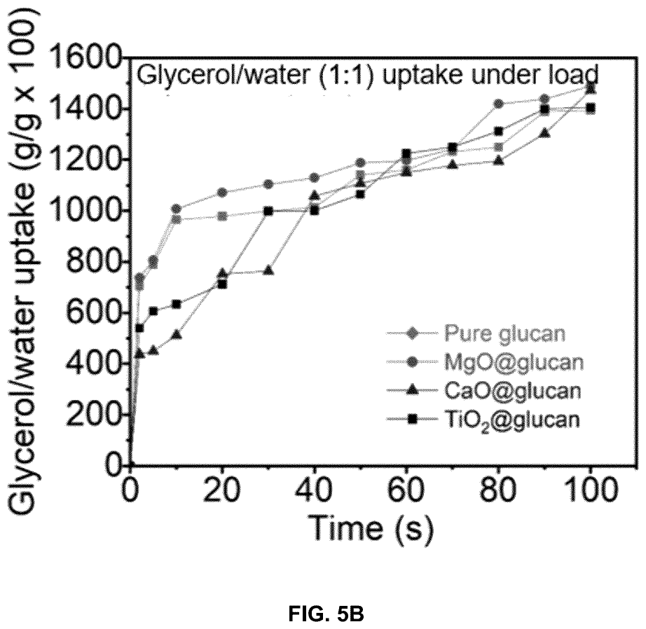

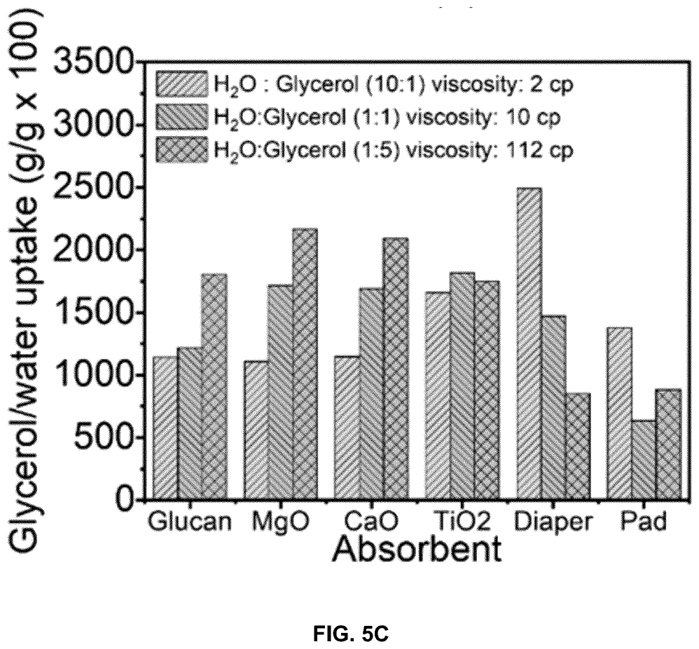

The water absorption capacity of aerogels was also tested with an aqueous NaCl solution (0.01 g/mL, “saline”, model for urine) (FIG. 4) or various aqueous glycerol solutions (1:10, 1:1, 5:1 glycerol:water [models for menstrual fluid]) (v/v) (FIGS. 5A-C). Tests were conducted as above, with or without load. The absorption capacities of a commercial diaper and sanitary pad under load in saline were measured to be about 17.50 and 4.6 g/g, respectively. The absorption capacities of a commercial diaper and sanitary pad under load in aqueous glycerol solution were also measured (FIG. 5C).

Since the foregoing absorption tests with the aerogels were performed with materials substantially larger in size (100 mg piece) as compared to the particles present in a diaper or pad, it is contemplated that rendering hybrid aerogels herein to smaller units/particles and using such comminuted material in a diaper, pad, or other similar product would provide significant aqueous liquid absorption capacity to the product.

Aeroqel Formation Mechanism: A mechanism for aerogel formation was proposed based on the in-depth understanding gained from the FTIR, XRD, SEM, TGA, rheology and confocal results of the present study. In the structure of the alpha-1,3-glucan, there are two types of oxygen atoms available for intramolecular interaction (i.e., the oxygen at the hydroxyl groups [O—H interaction], and at the ring [C—O— interaction]). They can be found at C2, C4, C6 (0-H group) and C1, C3 and C5 (C—O group), respectively. The charge on the oxygen at the hydroxyl (C2, C4, C6) is more negative than that on the C1, C3 and C5 because of the hydrogen ion (H⁺ effect). Thus, it is expected that the oxygen at C2, C4, and C6 interacts more readily with cations such as Na⁺, Ca⁺, Mg⁺, and Ti⁺ by displacing H⁺. At a high pH (e.g., >13.00), Na⁺ is in excess, and hence effectively interacts with those oxygens causing structural weakening, and particle dissolution. For alpha-1,3-glucan hydrogel precursor formation, gelation can be induced by reducing the pH through dilution or neutralization in which the Na⁺ strength is minimized, causing particle-particle interaction (intramolecular hydrogen bonding). Washing of the hydrogels removed the Na⁺ completely through which O—H groups were reorganized (intramolecular interaction), and hence a more stable solid structure was obtained. The sublimation of the ice crystals at the surface and within the structure of the frozen hydrogels via freeze-drying produced opened pores and mesopores, respectively.

The gelation process was enhanced after introducing foreign particles (hybrid materials) due to intermolecular hydrogen bonding. The presence of Mg⁺, Ca⁺, or Ti((OH)₃OCH(CH₃)₂)₄ in the alpha-1,3-glucan solution (with excess NaOH) resulted in an ionic exchange process. In that medium, Na⁺ reacted with Cl⁻ (present when magnesium chloride or calcium chloride was used), or (OH)₃OCH(CH₃)₂ anion, and Mg²⁺, Ca²⁺ or Ti⁴⁺ replaced Na⁺ attached to the oxygen at C2, C4, C6. When pH was reduced, reinforced structures were obtained because of the elimination of some of the NaOH species. However, due to their bivalent and tetravalent nature, Ca²⁺, Mg²⁺ and Ti⁴⁺ were likely to undergo different coordination with the alpha-1,3-glucan structure. Ca²⁺ and Mg²⁺, and Ti⁴⁺, formed two-points, and four-points, coordination with glucan structure, respectively, and hence produced MgO and CaO, and TiO₂, at the alpha-1,3-glucan structure. O—H stretch, C—O and C—O—C interaction (intramolecular interaction) of the alpha-1,3-glucan structure was found reduced (FTIR and XPS results) in the hybrid samples due to the intermolecular hydrogen. TiO₂ produced multivalent hydrogen bonding, which improved surface area, pore volume, and structural integrity.

Conclusions: This work demonstrates preparation of hydrophilic, microporous and self-standing alpha-1,3-glucan-based aerogels with superabsorbent performance. By using a co-precipitation method together with freeze-drying, aerogels with controlled properties were prepared. In particular, the co-precipitation method achieved production of hybrid MgO/glucan, CaO/glucan, and TiO₂/glucan aerogels, which were found to be excellent in applications for human hygiene. A detailed characterization of the aerogels revealed that the functional groups (O—H, C—O, C—O—C, C—C—H, and C—C) of alpha-1,3-glucan were successfully modulated upon in situ introduction of MgO, CaO, or TiO₂ due to intermolecular hydrogen bonding formation. Using two different sorption techniques, without load or under load, three different model fluids (DI water as baseline, saline water as urine, glycerol/water solution as menstrual discharge) were used to demonstrate that the hybrid glucan aerogels can be useful as absorbents in products for human hygiene. The hybrid glucan aerogels showed improved fluid uptake performance as compared to neat alpha-1,3-glucan aerogel. Among the hybrid glucan aerogels, TiO₂/glucan aerogel displayed the greatest fluid absorption capacity in all of the above absorption demonstrations. This performance was attributed to superior structural network and integrity, surface area, pore volume, and smaller pore sizes resulting from effective intermolecular hydrogen bonding between TiO₂ and alpha-1,3-glucan. It was also noteworthy that the absorption performance of hybrid glucan aerogels was generally superior to the absorption performance of commercial superabsorbents against liquid models of urine and menstrual fluid.

### AUXILIARY EXAMPLES

Formulations were developed and used to prepare molded microcellular foams comprising at least polyurethane and alpha-1,3-glucan. Such molded foams can be used in applications such as footwear (e.g., insoles) or other applications that employ cushioning materials, for example. The foams were prepared using the materials listed in Table 1 and following the criteria listed in Tables 2-3.

TABLE 1
Materials

| Designation | Identification | Supplier |
|---|---|---|
| VELVETOL H 2700 | Polytrimethylene ether glycol | Allessa |
| | (PO3G polyol) | |
| VELVETOL H 2000 | Polytrimethylene ether glycol | Allessa |
| | (PO3G polyol) | |
| 1,3-Propanediol | 1,3-PDO | CovationBio |
| (SUSTERRA) | | |
| Water | Deionized water | |
| TEGOSTAB B 4113 | Surfactant | Evonik |
| DABCO 33LV | 33% triethylenediamine (TEDA) in | Evonik |
| | dipropylene glycol | |
| DriCAT ® 8316 | Bismuth catalyst | Dura Chemicals Inc. |
| RUBINATE 44 | 4,4′-Methylenediphenyl diisocyanate | Huntsman |
| | (4,4′-MDI) | |
| LUPRANATE 81 | Carbodiimide isocyanate | BASF |
| NUVOLVE | alpha-1,3-glucan powder (15-micron) | IFF |

TABLE 2
Side A - Quasi NCO-prepolymer

| Designation | MM-PP |
|---|---|
| LUPRANATE 81 | 7.80 |
| RUBINATE 44 | 31.22 |
| VELVETOL H 2700 | 9.70 |
| NCO % | 25.42 |

TABLE 3
Microcellular Elastomers Molded

| | | | |
|---|---|---|---|
| | 1 | 2 | 3 |
| Designation | 50/50-CAT-100ii | 50/50-CAT-102ii | 50/50-CAT-105ii |

Side B - Polyol System (50° C.)

| | | | |
|---|---|---|---|
| VELVETOL H 2700 | 40.20 | 40.20 | 40.20 |
| VELVETOL H 2000 | 28.10 | 28.10 | 28.10 |
| 1,3-PDO | 5.0 | 5.0 | 5.0 |
| Added water | 0.77 | 0.77 | 0.77 |
| TEGOSTAB B 4113 | 0.33 | 0.33 | 0.33 |
| DABCO 33LV | 0.62 | 0.62 | 0.62 |
| DriCAT ® 8316 | 0.010 | 0.010 | 0.010 |
| NUVOLVE | 7.18 | 7.18 | 7.18 |

Side A - Isocyanate System (50° C.)

| | | | |
|---|---|---|---|
| Isocyanate Index, % | 100% | 102% | 105% |
| MM-PP (Quasi-iso), g | 40.94 | 40.94 | 40.94 |
| Rubinate 44, g | 7.22 | 8.19 | 9.63 |
| Total Iso amt, g | 48.16 | 49.13 | 50.57 |

Various properties of the prepared foams were assessed (Table 4).

TABLE 4
Microcellular Elastomers Properties

| | 1 | 2 | 3 |
|---|---|---|---|
| Designation | 50/50-CAT-100ii | 50/50-CAT-102ii | 50/50-CAT-105ii |
| Molded Density, | 0.217 | 0.202 | 0.207 |
| g/mL | | | |
| Skin Hardness, | 29 | 30 | 36 |
| Asker C | | | |
| Resilience, | 41 | 40 | 42 |
| Ball Rebound, % | | | |
| Compression set, | 4.06% ± 0.36 | | 3.22% ± 0.08 |
| 50° C., 22 hours | | | |

TABLE 5
Microcellular Elastomers Properties Comparison

| | | | | | INSITE |
|---|---|---|---|---|---|
| | NUVOLVE | Sneaker | | INSITE | EcoComfort 50 |
| | 50/50-CAT-105ii | Proprietor 1 | | EcoComfort 11 | High Rebound |
| | (see Tables 3-4) | Requirements | | Standard Foam | Foam |
| Molded Density, | 0.2 | 0.2 | | 0.3 | 0.3 |
| g/mL | | | | | |
| Skin Hardness, | 36 | 30-35 | | 26 | 26 |
| Asker C | | | | | |
| Resilience, | 42 | 40 | min | 50 | 55 |
| Ball Rebound, % | | | | | |
| Compression set, | 3% | 20% | max | 20% max* | 45% max* |
| 50° C., 22 hours | | | | | |
| Biocontent, | 72% | 50% | min | 11% | 50% |
| wt. % | | | | | |

*tested at 70° C.

Additional molded foams were prepared to examine the effects of including (i) SUSTERRA (propanediol) only, or (ii) a combination of SUSTERRA and NUVOLVE (alpha-1,3-glucan), as bio-derived components of the prepared foam. In particular, the foam product INSITE ECOCOMFORT TERRAIN F71 comprised about 50 wt % SUSTERRA, while the foam product INSITE ECOCOMFORT TERRAIN IF99 comprised about 45 wt % SUSTERRA and about 5 wt % NUVOLVE. Both the F71 and IF99 products comprised about 50 wt % petrol-based diisocyanate polyurethane. Properties of these molded foams are listed in Table 6.

TABLE 6
Properties Comparison of Additional
Microcellular Elastomer Products

| | | INSITE ® | INSITE ® |
|---|---|---|---|
| | INSITE ® | EcoComfort ® | EcoComfort ® |
| | Terrain F32 | Terrain F71 | Terrain IF99 |
| Biobased content | NA (petrol- | 50% Susterra ® | 45% Susterra ® |
| | based PU only) | | 5% Nuvolve ® |
| Hardness | 25 ± 3 Asker C | 25 ± 3 Asker C | 20 ± 3 Asker C |
| Density | 0.28 g/cm³ | 0.30 g/cm³ | 0.28 g/cm³ |
| Resilience | 44% | 58% | 34% |
| Compression Set | 49.5% | 42.6% | 11.3% |
| Tear Strength | AL: 2.5 | AL: 1.5 | 5.8 |
| | AC: 2.2 | AC: 1.3 | |
| Tensile Strength | AL: 5.0 | AL: 8.5 | 11.6 |
| | AC: 4.9 | AC: 8.3 | |
| Elongation | AL: 324.0 | AL: 504.0 | 478 |
| | AC: 314.7 | AC: 476.0 | |

What is claimed is:

1. A composition comprising an aerogel, wherein the aerogel comprises a water-insoluble alpha-glucan and a metal oxide, wherein at least about 50% of the glycosidic linkages of the insoluble alpha-glucan are alpha-1,3 linkages, and wherein the metal oxide is calcium oxide (CaO), magnesium oxide (MgO), or titanium dioxide (TiO₂).

2. The composition of claim 1, wherein at least about 90% of the glycosidic linkages of the water-insoluble alpha-glucan are alpha-1,3 glycosidic linkages.

3. The composition of claim 1, wherein the water-insoluble alpha-glucan has a weight-average degree of polymerization (DPw) of at least about 10.

4. The composition of claim 3, wherein the DPw is at least about 400.

5. The composition of claim 1, wherein the metal oxide is said titanium dioxide (TiO₂).

6. The composition of claim 1, wherein the aerogel comprises less than about 20 wt % of the metal oxide, optionally wherein the balance of the mass of the aerogel is of the water-insoluble alpha-glucan.

7. The composition of claim 1, wherein the metal oxide interacts with the water-insoluble alpha-glucan via hydrogen bonding.

8. The composition of claim 1, wherein the aerogel has been comminuted.

9. The composition of claim 1, wherein the aerogel further comprises water or an aqueous liquid, typically wherein the water or aqueous liquid was absorbed by the aerogel, optionally wherein the aerogel is under load.

10. The composition of claim 1, wherein the composition is a personal care product, household care product, medical product, pharmaceutical product, or industrial product, and/or the composition is an absorbent product.

11. An aqueous caustic solution comprising (i) an aqueous caustic solvent, (ii) a water-insoluble alpha-glucan, and (iii) a metal hydroxide,
wherein at least about 50% of the glycosidic linkages of the water-insoluble alpha-glucan are alpha-1,3 glycosidic linkages,
wherein the water-insoluble alpha-glucan is dissolved in the aqueous caustic solvent and the metal hydroxide is not dissolved in the aqueous caustic solvent, and
wherein the metal hydroxide is calcium hydroxide, magnesium hydroxide, or titanium hydroxide.

12. The aqueous caustic solution of claim 11, wherein at least about 90% of the glycosidic linkages of the water-insoluble alpha-glucan are alpha-1,3 glycosidic linkages.

13. The aqueous caustic solution of claim 11, wherein the water-insoluble alpha-glucan has a weight-average degree of polymerization (DPw) of at least about 10.

14. The aqueous caustic solution of claim 11, wherein aqueous caustic solvent comprises at least one alkali hydroxide.

15. A method of producing an aerogel, said method comprising:
(a) providing an aqueous caustic solution according to claim 11,
(b) putting the aqueous caustic solution into a desired form,
(c) chemically or ionically modifying the aqueous caustic solvent such that the water-insoluble alpha-glucan and the metal hydroxide are undissolved in the solvent, whereby a hydrogel is produced, and
(d) removing all of the water, or most of the water, from the hydrogel, whereby an aerogel is produced.

16. The method of claim 15, wherein step (a) comprises combining a salt of the metal hydroxide with an aqueous caustic solution in which the water-insoluble alpha-glucan is dissolved, typically wherein the salt is provided as dissolved in an aqueous solution, and the metal hydroxide precipitates out of solution upon being combined with the aqueous caustic solution.

17. The method of claim 15, wherein step (c) comprises reducing the pH of the caustic solution to a pH that renders the water-insoluble alpha-glucan to be undissolved in the solvent.

18. The method of claim 15, wherein step (c) further comprises keeping the solution still during formation of the hydrogel.

19. The method of claim 15, wherein step (d) comprises freeze-drying or supercritical drying the hydrogel to form the aerogel.

20. An absorption method that comprises contacting a composition according to claim 1 with an aqueous liquid-comprising composition, wherein the composition absorbs aqueous liquid from said aqueous liquid-comprising composition.
